(19) United States
(12) Patent Application Publication
(10) Pub. No.: US 2026/0290174 A1
(43) Pub. Date: Sep. 24, 2026

(54) METHOD OF PLANNING FLIGHT PATH OF MULTIPLE UNMANNED AERIAL VEHICLES OVER MULTIPLE REGIONS

(71) Applicant: KING FAHD UNIVERSITY OF PETROLEUM AND MINERALS, Dhahran (SA)

(72) Inventors: Gamil Abdullah Mohsen AHMED, Dhahran (SA); Tarek Rahil Omar SHELTAMI, Dhahran (SA); Ashraf Sharif Hasan MAHMOUD, Dhahran (SA)

(73) Assignee: KING FAHD UNIVERSITY OF PETROLEUM AND MINERALS, Dhahran (SA)

(21) Appl. No.: 19/082,790

(22) Filed: Mar. 18, 2025

(51) Int. Cl. G08G 5/34; G08G 5/56; G08G 5/57; G08G 5/59

(52) U.S. Cl. CPC G08G 5/34; G08G 5/56; G08G 5/57; G08G 5/59

(57) ABSTRACT

A method of planning a flight path of a plurality of unmanned aerial vehicles (UAVs) over one or more regions includes receiving a boundary information of the one or more regions; decomposing the one or more regions into a plurality of point of interests (POIs) based on the boundary information; determining a line sweep direction for each POI of the plurality of POIs to minimize a number of turns to achieve a predetermined coverage; generating an intra-region path in each POI of the plurality of POIs; generating a back-and-forth path pattern for the intra-region paths based on the line sweep direction; formulating a problem matrix by calculating an inter-region energy; solving the problem matrix with a heuristic approach and an exact approach; and determining the flight path based on the heuristic approach and the exact approach.

### STATEMENT OF PRIOR DISCLOSURE BY AN INVENTOR

Aspects of the present disclosure were described in Ahmed, G., Sheltami, T. & Mahmoud, A. Energy-Efficient Multi-UAV Multi-Region Coverage Path Planning Approach. Arab J Sci Eng 49, 13185-13202 (2024), incorporated herein by reference in its entirety.

### STATEMENT OF ACKNOWLEDGEMENT

Support provided by the Interdisciplinary Center of Smart Mobility and Logistics under project INML2104 at King Fahd University of Petroleum and Minerals (KFUPM) is gratefully acknowledged.

### BACKGROUND

### Technical Field

The present disclosure is directed to unmanned aerial vehicles, and more particularly relates, to a method of planning the flight path of multiple unmanned aerial vehicles over multiple regions.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Unmanned aerial vehicles (UAVs) have garnered significant attention due to rapid technological advancements. These vehicles offer remarkable capabilities, such as enhanced mobility and the ability to be deployed instantly and flexibly. As a result, UAVs are widely used in various military and commercial applications, including traffic control, aerial surveillance, area coverage, search and rescue, disaster management, traffic policing, and precision agriculture. However, the capability of a single UAV is limited by factors such as sensing range, energy, and communication bandwidth are often insufficient for more complex tasks. In these cases, the demand for advanced operations frequently exceeds the capabilities of individual UAVs. To address this growing complexity, the use of multiple UAVs becomes essential.

When using multiple UAVs to complete a task, a crucial factor is the path planning for each UAV. Path planning is generally categorized into two types. The first type is point-to-point path planning, which aims to determine the optimal path from one point to another. The second type is coverage path planning (CPP), which focuses on determining the most efficient flight trajectory for each UAV based on a predefined objective. The CPP ensures comprehensive area coverage, ensuring that every point within the area is visited or covered.

Performing the CPP for multiple UAVs becomes increasingly complex when dealing with multiple separated regions, presenting significant computational challenges. Developing multi-UAV CPP technology is particularly difficult in large-scale and complex environments, as it requires addressing numerous CPP constraints. Some challenges in multi-UAV area coverage include coordination and task allocation, both of which are heavily influenced by the position of each UAV. Additionally, mission time and energy consumption are key metrics for evaluating the efficiency of coverage path planning. These metrics are primarily influenced by factors such as the number of turns the UAVs make and the overall path length of the mission. Given the limited battery power of UAVs, flight duration is constrained by battery capacity. As a result, minimizing time costs is also crucial when determining the optimal coverage path. Due to these battery limitations, the CPP task covering multiple regions may result in partial area coverage, necessitating the cooperation of multiple UAVs to ensure efficient task completion.

Several approaches have been proposed to optimize coverage path planning for multiple UAVs. For example, a patent application WO2023193100A1 discloses a method for deploying UAVs in a service area that considers predefined constraints, along with associated priority weights, penalty factors, and compactness scores to select the number of UAVs to deploy. Another patent application, CN116433845A, presents a method for UAV path planning, where one or more UAVs cooperate to rapidly model a complex environment, taking into account route planning and position information acquisition factors. A research-based literature in the art proposed a method for CPP for multiple UAVs considering optimal flight speed to minimize energy consumption per unit of distance, along with an energy consumption estimation algorithm during the planning phase (See: Denys Datsko, Frantisek Nekovar, Robert Penicka and Martin Saska, “Energy-aware multi-UAV coverage mission planning with optimal speed of flight”, IEEE Robotics and Automation Letters, Volume 9, Issue 3, March 2024). Another literature proposed a heuristic approach for CPP by considering flying speed and scan width for multiple UAVs (See: Jian Chen, Ruikang Zhang, Hongqiang Zhao, Jiejie Li and Jilin He, “Path planning of multiple unmanned aerial vehicles covering multiple regions based on minimum consumption ratio”, Aerospace 2023, Volume 10, Issue 2, January 2023). The UAVs' trajectories are then optimized using a dynamic planning algorithm to reduce time spent on transfer paths between regions. In addition to the methods referenced in prior arts, mixed integer linear programming (MILP) has also been applied in several approaches to address multiple constraints when planning paths for multiple UAVs. For example, dynamic programming and branch-and-bound are exact optimization methods that solve the problem optimally by formulating it as a MILP.

Some of the aforementioned references focus on covering a single region, while the challenge of covering multiple regions has received comparatively less attention. Many references assume that a drone has sufficient energy to cover the entire area of interest. However, the limitations of energy capacity and consumption are not adequately addressed when planning coverage paths for multiple UAVs across multiple regions. Furthermore, the MILP-based approaches for path planning are often ineffective due to their time-consuming nature and inability to handle hard constraints within a reasonable timeframe. Even other approximation techniques, such as tabu search, simulated annealing, and particle swarm optimization (PSO), which have been developed to tackle the single-region CPP problem, show limited efficiency when applied to identifying an optimal coverage path for multiple areas using multiple UAVs. Moreover, the prior art primarily focuses on shortest path coverage, often overlooking the crucial aspect of energy consumption, which is also influenced by several factors such as drone acceleration, deceleration, distance traveled, and speed.

Therefore, there is a need for a method or system for path planning involving multiple UAVs across multiple regions, with a focus on determining the optimal trajectory for each UAV. The goal is to maximize area coverage while minimizing both mission time and overall energy consumption, while considering various factors such as UAV acceleration, deceleration, distance traveled, and speed.

### SUMMARY

Considering the limitations in the prior art, a method of planning a flight path of a plurality of unmanned aerial vehicles (UAVs) over one or more regions is disclosed, according to an exemplary embodiment. The method includes receiving a boundary information of the one or more regions. The method further includes decomposing the one or more regions into a plurality of point of interests (POIs) based on the boundary information. The method further includes determining an optimal line sweep direction for each POI of the plurality of POIs to minimize a number of turns to achieve a predetermined coverage. The method further includes generating an intra-region path in each POI of the plurality of POIs. The method further includes generating a back-and-forth path pattern for the intra-region paths based on the optimal line sweep direction. The method further includes formulating a problem matrix by calculating an inter-region energy. The method further includes solving the problem matrix with a heuristic approach and an exact approach. The method further includes determining the flight path based on the heuristic approach and the exact approach.

In another exemplary embodiment, the problem matrix is formulated based on a mixed integer linear programming (MILP).

In another exemplary embodiment, the generating the intra-region path further includes a method comprising finding a swap direction of each POI of the plurality of POIs. The method further includes creating a rough intra-region path based on a back-and-forth model. The method further includes adjusting the rough intra-region path based on a smoothing turns approach. The method further includes calculating an intra-region energy and generating the intra-region path in each POI of the plurality of POIs.

In another exemplary embodiment, the smoothing turns approach minimizes an energy consumption during a turning maneuver of a UAV of the plurality of UAVs.

In another exemplary embodiment, the smoothing turns approach reduces the energy consumption by optimizing a deceleration, a rotation, and an acceleration of the turning maneuver of the UAV of the plurality of UAVs.

In another exemplary embodiment, the smoothing turns approach uses Bezier curves configured to reduce a turn sharpness.

In another exemplary embodiment, the flight path is determined based on a number of UAVs of the plurality of UAVs, the intra-region energy, and the inter-region energy.

In another exemplary embodiment, the flight path is determined further based on a Tabu Search algorithm and a greedy approach solution.

In another exemplary embodiment, the back-and-forth path pattern determines the optimal line sweep direction perpendicular to a region's edge to minimize the number of turns.

In another exemplary embodiment, a UAV of the plurality of UAVs is configured to return to a base station for refueling based on a calculated remaining energy reserve.

In another exemplary embodiment, the determined flight path maximizes continuous UAV communication with the base station.

In another exemplary embodiment, the method further includes determining an updated flight path in real-time when a change in an environmental condition is detected.

In another exemplary embodiment, the determined flight path minimizes an overlap in covered areas between adjacent flight paths for each UAV of the plurality of UAVs.

In another exemplary embodiment, each UAV of the plurality of UAVs is equipped with a downward-facing imaging device, and the predetermined coverage is determined based on image data from the imaging device.

In another exemplary embodiment, the method further includes determining an energy consumption for the intra-region path based on a number of waypoints and a number of turns in the intra-region path.

In another exemplary embodiment, the method further includes calculating an energy consumption for an inter-region path based on a distance between an exit point of a first region and an entry point of a second region.

In another exemplary embodiment, the method further includes grouping the one or more regions into clusters based on a number of the plurality of UAVs available and a spatial distribution of the one or more regions.

In another exemplary embodiment, the method further includes determining a region allocation by assigning the one or more regions to the plurality of UA Vs based on starting positions of the plurality of UAVs and energy capacities of the plurality of UAVs.

In another exemplary embodiment, the method further includes calculating energy requirements for the intra-region path based on takeoff, hovering, cruise, turning, and landing.

In another exemplary embodiment, the plurality of UAVs maintain a fixed altitude during operation.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A illustrates an exemplary flow diagram of a method of planning flight path of plurality of unmanned aerial vehicles (UAVs) over plurality of regions to entirely cover plurality of separated regions to minimize overall energy consumption of one or more UAVs of plurality of UAVs, according to certain embodiments.

FIG. 1B illustrates Algorithm 1 for executing the method of planning the flight path of a plurality of unmanned aerial vehicles (UAVs) over multiple regions to minimize the overall energy consumption of one or more UAVs, according to certain exemplary embodiment.

FIG. 2A illustrates an environment to illustrate an overview of a camera footprint on ground, according to certain embodiments.

FIG. 2B illustrates an environment showing a footprint sweep on the ground while a UAV is undergoing a flight path, according to certain embodiments.

FIG. 3 illustrates a decomposition of a target region into multiple cells, according to certain embodiments.

FIG. 4A illustrates an exemplary diagram for computing optimal line sweep direction, according to certain embodiments.

FIG. 4B illustrates a smoothing turns approach to decrease energy consumption during turning maneuvers of UAV for rectangular region of interest, according to certain embodiments.

FIG. 4C illustrates a smoothing turns approach for decreasing energy consumption during turning maneuvers of UAVs for non-rectangular regions of interest, according to certain embodiments.

FIG. 5A illustrates an environment for computation of optimal group and visiting orders for a plurality of regions by multiple UAVs, according to certain embodiments.

FIG. 5B illustrates a two-dimensional view of multi-UAV and multi-region coverage path planning for three UAVs, according to certain embodiments.

FIG. 5C illustrates Algorithm 2 for applying a region allocation approach effectively, according to certain embodiments.

FIG. 5D illustrates Algorithm 3 for executing the tabu search, according to certain exemplary embodiments.

FIG. 5E illustrates Algorithm 4 for executing a Greedy search, according to certain exemplary embodiments.

FIG. 6A illustrates an Intra-region CPP performance curve for analyzing an average energy consumption with respect to region size, according to certain embodiments.

FIG. 6B illustrates an Intra-region CPP performance curve for analyzing an average energy consumption with respect to number of turns, according to certain embodiments.

FIG. 6C illustrates an Inter-region CPP performance curve for analyzing performance of a single UAVs multiple disjoint regions, according to certain embodiments.

FIG. 7A illustrates an Inter-region CPP performance statistic for analyzing performances of multiple UAVs in multiple disjoint regions using Greedy search, Tabu search, and MILP-based search, according to certain embodiments.

FIG. 7B illustrates an Inter-region CPP performance statistic for analyzing effect of region allocation optimization in conserving energy of multiple UAVs multiple disjoint regions, according to certain embodiments.

FIG. 8A illustrates an average energy consumption curve with respect to number of way points for intra-region CPP performance, according to certain embodiments.

FIG. 8B illustrates an average energy consumption curve with respect to number of UAV for plurality of optimal path determination approach, according to certain embodiments.

FIG. 9 illustrates a flowchart of a method of planning a flight path of a plurality of unmanned aerial vehicles over one or more regions, according to certain embodiments.

FIG. 10 is an illustration of a non-limiting example of details of computing hardware used in the computing system, according to certain embodiments.

FIG. 11 is an exemplary schematic diagram of a data processing system used within the computing system, according to certain embodiments.

FIG. 12 is an exemplary schematic diagram of a processor used with the computing system, according to certain embodiments.

FIG. 13 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Further, the terms “region of interest”, “area of interest”, “target region”, ROI and AOI represent same terms and are used throughout the disclosure synonymously.

Further, the terms “unmanned aerial vehicle”, “UAV”, and “drone” represent same terms and are used throughout the disclosure synonymously.

Further, the terms “waypoints”, “point of interest”, and “POI” represent same terms and are used throughout the disclosure synonymously.

Further, the terms “camera footprint” and “predetermined coverage” may represent same terms and are used throughout the disclosure synonymously.

The disclosure describes a method for energy-efficient multi-unmanned aerial vehicle (UAV), multi-region coverage path planning aimed at covering multiple separated regions while minimizing overall energy consumption. In this method, multiple UAVs start from different depots and ensure efficient and effective coverage across the regions. An optimal trajectory for each UAV is determined by minimizing overall energy consumption while maximizing coverage area. Initially, a back-and-forth (BAF) algorithm is used to establish efficient search patterns and routes in an intra-region of interest (RoI), effectively reducing the number of turns each UAV encounters. To further reduce energy consumption, the method incorporates a smoothing turns approach (STA) based on Bezier curves, which smooths sharp turns, minimizing energy loss caused by abrupt maneuvers. Furthermore, an inter-region CPP problem is formulated as a MILP optimization problem, which is solved using a combination of exact and approximate solutions for small-scale and large-scale problems, respectively. In the inter-region CPP, the invention optimally identifies each region's entry and exit points, the optimal visiting order of RoIs, using both exact and heuristic solutions. To minimize energy consumption, an optimization approach for region allocation is applied, which optimally assigns regions to multiple UAVs, thereby reducing overall energy consumption. This approach ensures that Rols are allocated to the most suitable UAVs, with each UAV starting from its respective depot. To further optimize energy use, the entrance and exit points at each region are chosen such that traveling between regions consumes the least energy. A CPLEX solver is utilized for small-scale inter-region CPP problems, while heuristic methods are used for large-scale ones, reflecting a practical strategy. Overall energy consumption optimization results in promising outcomes regarding solution quality and energy consumption for multiple UAVs across multiple regions. A detailed explanation of the invention is provided in the following description.

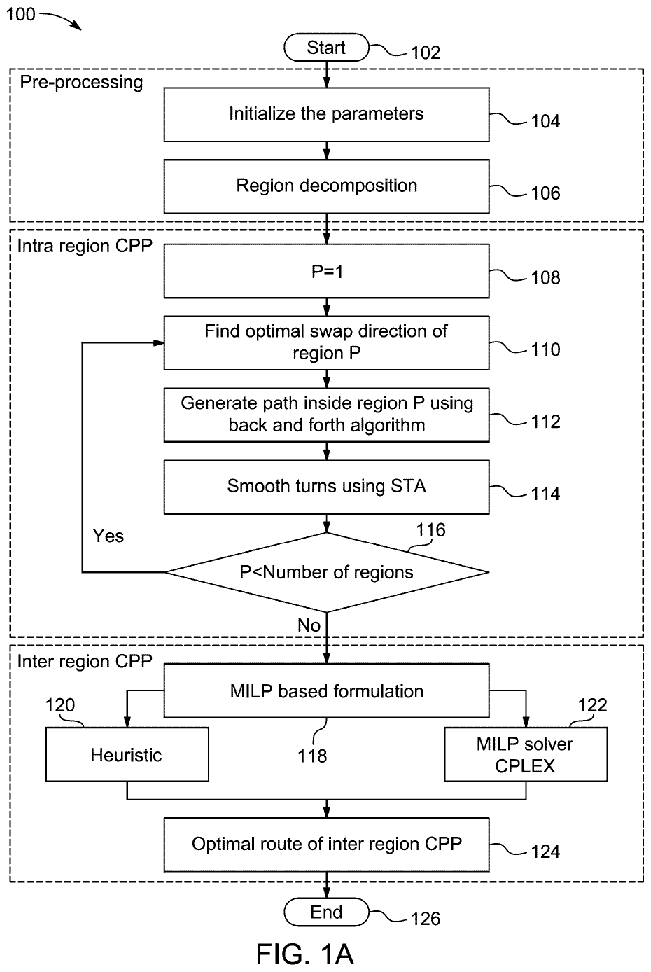

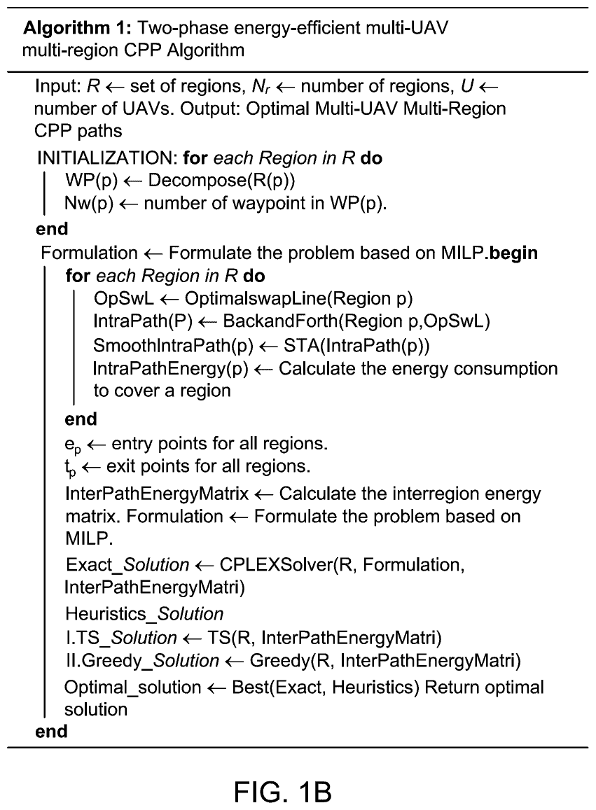

FIG. 1A illustrates an exemplary flow diagram 100 of a method of planning the flight path of a plurality of unmanned aerial vehicles (UAVs) over a plurality of regions to entirely cover the plurality of separated regions to minimize the overall energy consumption of one or more UAVs, according to an exemplary embodiment. The separated regions refer to multiple regions with some distance, for example, 500 meters or 1 km, 2 km, 3 km, etc., in between them. The flow diagram 100 includes multiple steps to optimize a coverage path planning (CPP) for one or more UAVs for one or more regions to be surveyed. The flow diagram 100 includes a start block 102 to begin execution of the method of planning the flight path of a plurality of UAVs over a plurality of regions. In block 102, an algorithm (Algorithm 1) may be executed on a processing device (not shown), such as a laptop, desktop, mobile phone, cellphone, or similar, capable of processing a specific amount of data. Algorithm 1 is illustrated in FIG. 1B and briefly described herein.

FIG. 1B illustrates Algorithm 1 for executing the method of planning the flight path of a plurality of unmanned aerial vehicles (UAVs) over multiple regions to minimize the overall energy consumption of one or more UAVs, according to an exemplary embodiment. Algorithm 1 is configured to accept multiple inputs, such as the number of regions, the set of regions, the number of UAVs, etc. The output of Algorithm 1 is the energy-efficient trajectory or paths for one or more UAVs across one or more regions. During the execution phase of Algorithm 1, multiple processes are carried out. These processes include collecting boundary information, region decomposition, determining the optimal line sweep direction, using a back-and-forth approach to generate a rough intra-region path, using a smoothing turn approach to reduce energy consumption at corners, and calculating the energy for the intra-region. The processes also include determining inter-region energy, creating a problem matrix, and applying one or more approaches, such as heuristic and exact approaches, to solve the problem matrix and determine the energy efficient one or more flight paths. The brief description of Algorithm 1 is introductory only. Each individual process is described in detail in FIG. 1A.

Referring back to FIG. 1A. Initially, an aerial survey of a region or land area is conducted before the actual commencement of the survey using one or more UAVs. An aerial survey may be carried out using, for example, a flying object equipped with a downward-facing imaging device that is configured to obtain images or video (or imaging data) of the survey area. The flying object may include, but is not limited to, a drone, a quadcopter, a multicopter, a quadrotor, or similar devices. The region may refer to agricultural land, forest land, construction sites, buildings, or other similar areas. The aerial survey of the region may also be performed using a mapping service for the concerned area, such as Google Maps. As such, the properties of the region to be surveyed may be known beforehand. Similarly, the aerial survey of multiple other regions is performed in advance to identify various parameters for each region. Additionally, the region may also be referred to as a region of interest (ROI) or an area of interest (AOI). The plurality of regions may be adjacent to each other or separated by a certain distance, with each region representing a target area for the survey.

Once the aerial survey of one or more regions is complete and the imaging data of the regions are obtained, various parameters of the regions are identified, which may be determined before the actual deployment of one or more UAVs at the commencement of the survey. These parameters may include the periphery, perimeter, coordinates, total land surface area, region boundaries, or other relevant features of the regions. The process, including imaging the region and identifying parameters such as the periphery, perimeter, and region boundaries, may be referred to as the ‘parameter initialization block 104 in FIG. 1A, which is the first part of the pre-processing phase. In one embodiment, the region boundaries of one or more regions are determined. These boundaries may also be derived from the coordinates of the region on a geographical map, for example, for a square, rectangular, circular, triangular area, or other similar shapes. The identification of the region boundary is considered exemplary for further processing. However, other parameters, such as the surface area of the region, may also be considered for further processing, and the analysis is not limited to just the region boundary.

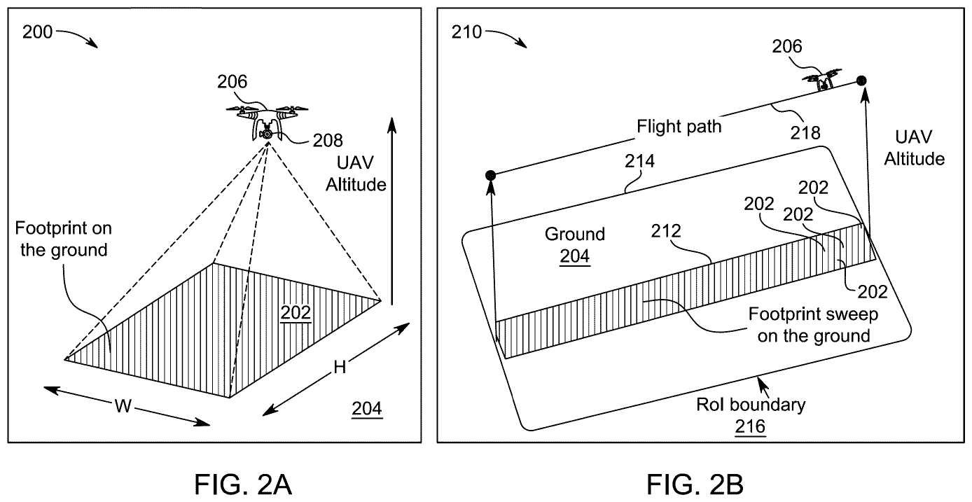

Upon receiving the boundary information, each target region is decomposed into a plurality of cells that need to be surveyed at the time of deployment of one or more UAVs. In one embodiment, the plurality of regions is decomposed using a grid-based approach to divide the region into a plurality of cells. For example, once the region boundaries are obtained, the volume of the footprint of the camera equipped on the UAV may be identified, which would cover the target region in a single sweep. Accordingly, the size of the cell that would be covered in a single sweep may be determined beforehand. This is illustrated in more detail in FIGS. 2A and 2B.

FIG. 2A illustrates environment 200 to provide an overview of a camera footprint 202 on the ground 204, according to an embodiment. The environment 200 includes, for example, an unmanned aerial vehicle (UAV) 206 equipped with a downward-facing imaging device 208, such as a camera. At the time of actual deployment of the plurality of UAVs, the range of the imaging device 208 of interest may have to be identified that would cover area on the ground 204 in a single sweep when the UAV 206 equipped with the downward-facing imaging device 208 is maintained at a fixed altitude throughout the entire survey operation.

When the downward-facing imaging device 208 is powered on during a survey operation, the imaging device 208 covers the ground 204 and captures a predetermined coverage area on the ground 204. This predetermined coverage is referred to as a camera footprint 202. The camera footprint 202 or the predetermined coverage may have a rectangular shape with width ‘W’ and length ‘H’. As such, the camera footprint 202 may cover a predetermined area of W*H square units in a single sweep with one camera flash or one frame capture. In an embodiment, the camera footprint 202 may also have other predefined shapes, such as, but not limited to, a square, triangle, circle, or similar shapes. For simplicity, the camera footprint 202 is considered to have a rectangular shape to cover a large area. In an embodiment, the downward-facing imaging device 208 may include, but is not limited to, an RGB camera, infrared camera, 3D camera, TOF-based camera, a visible light-based camera, or the like. When the altitude of the UAV 206 is greater than a predetermined height, the predetermined coverage 202 may be large, but the image quality can be impacted. On the other hand, when the altitude of the UAV 206 is lower than the predetermined height, the image quality may be high, but the predetermined coverage 202 may be small. Accordingly, a predetermined and predefined height is preferred and selected to achieve the proper coverage area as the footprint 202, as well as adequate image quality. In an example, the fixed altitude may refer to a defined height such as 5, 10, 15, 20 meters, or another suitable value. The predetermined coverage 202 of the imaging device 208 may support covering the imaging area with clear images of the region. Based on the camera footprint 202 on the ground 204, the predetermined coverage 202 is determined using image data from the imaging device 208. This is further illustrated with reference to FIG. 2B.

FIG. 2B illustrates an environment 210 showing a footprint sweep 212 on the ground 204 while the UAV 206 follows a flight path 218, according to an embodiment. The UAV 206 is configured to cover a certain region of interest (ROI) 214 on the ground 204 during the survey. The region of interest (ROI) 214 on the ground 204 has an ROI boundary 216, which is a computed parameter in block 102 of FIG. 1A, marking the selected region of interest 214 for the survey. While the UAV 206 follows flight path 218 at a defined altitude within the ROI boundary 216, the imaging device 208 in FIG. 2A on the UAV 206 projects the footprint sweeps 212 onto the ground 204 in a straight line. The footprint sweeps 212 consists of multiple footprints 202, as shown in FIG. 2A. In other words, the footprint 202 in FIG. 2A is defined part of the footprint sweep 212. Accordingly, during the survey, the area of the strip, i.e., the footprint sweeps 212, is defined to be covered in the single flight path 218 in a given direction. As such, the area of the footprint 202 on the ground 204 may be known beforehand, as it is utilized during the decomposition of the region of interest 214 into a plurality of cells. The footprint 202 on the ground 204 determines the total predetermined coverage based on image data from the imaging device 208, where the predetermined coverage 202, as the footprint 202 on the ground 204, sums up to the total predetermined coverage, which is the footprint sweep 212 on the ground 204, in the single sweep of the UAV 206 while crossing the boundary of ROI.

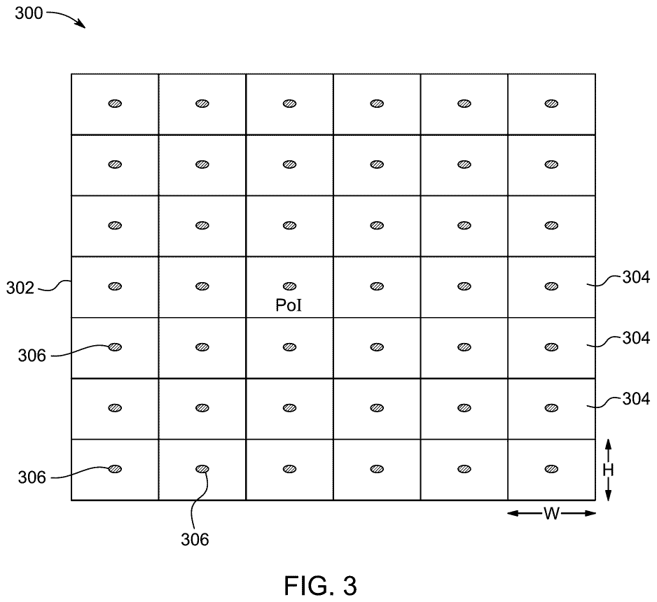

Referring back to FIG. 1A and covering the fundamental information of the footprint 202 and the total footprint sweep 212 on the ground 204, as discussed in FIG. 2A and FIG. 2B, the one or more regions of interest 214 may be decomposed, using a grid-based approach, to divide the target region of interest 214 into a plurality of cells. The division of the target region of interest 214 into multiple cells is illustrated in detail in FIG. 3.

FIG. 3 illustrates the decomposition of a target region 300 into multiple cells 304, according to an embodiment. The target region 300 is illustrative of the target region of interest 214 in FIG. 2B. The target region 300 has a region boundary 302, which is illustrative of the ROI boundary 216 in FIG. 2B. The target region 300 is decomposed into multiple cells 304 based on the drone camera footprint 202. For example, each cell 304 has a width ‘W’ and height ‘H’ that corresponds to the width ‘W’ and height ‘H’ of the footprint 202 of the imaging device 208 of the UAV 206 on the ground 204, as discussed in FIG. 2A. Accordingly, based on the dimensions W and H of the footprint 202, the target region 300 is divided into multiple cells 304.

Further, each cell 304 includes a waypoint, also referred to as a point of interest (POI) 306. Each respective POI 306 indicates the midpoint of its respective cell 304, which can be fully covered during the survey when the UAV 206 with the imaging device 208 passes through its centre (i.e., POI 306). Accordingly, the target region 300 may include multiple POIs 306, for example, N, and each cell 304 can be fully covered when the UAV 206 passes through the centre (i.e., POI 306) at a fixed altitude. Similarly, each target region may be decomposed into a plurality of points of interest (POIs) based on the boundary information. The process of decomposing the plurality of target regions of interest 214 and 300 may be referred to as the ‘region decomposition block 106’ in FIG. 1A, which is the second part of the pre-processing phase.

Referring back to FIG. 1A, once the target region of interest 214, 300 is decomposed into a plurality of points of interest (POIs) based on the boundary information, an optimal line sweep direction for each POI within each target region of interest 214, 300 is determined for a first region indicated by a block 108. The optimal sweep direction refers to the direction of the UAV during the survey that minimizes the number of turns needed to achieve the predetermined coverage. At this point, sufficient paths are generated with a minimum number of turns to cover each region effectively.

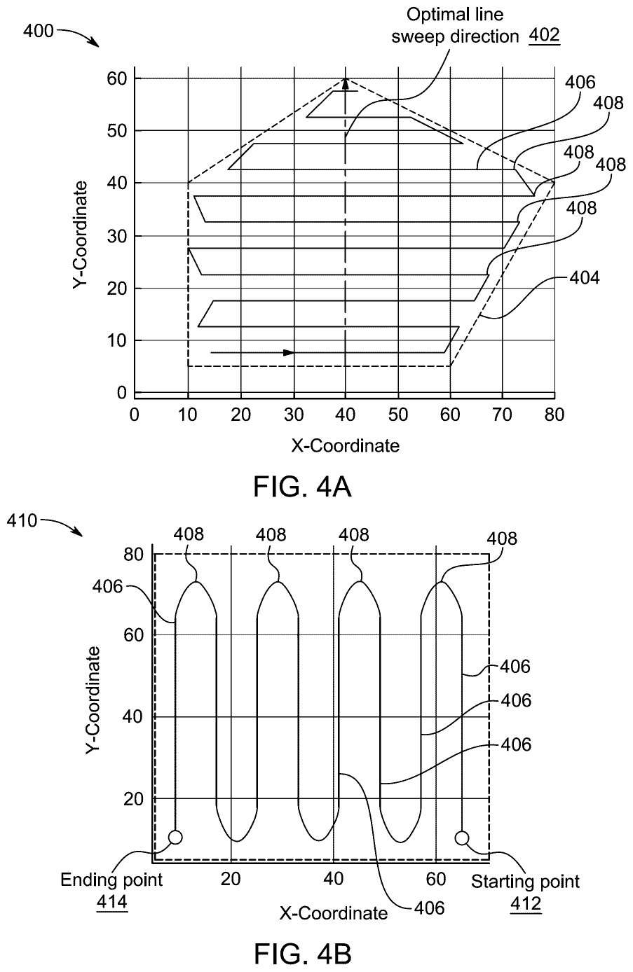

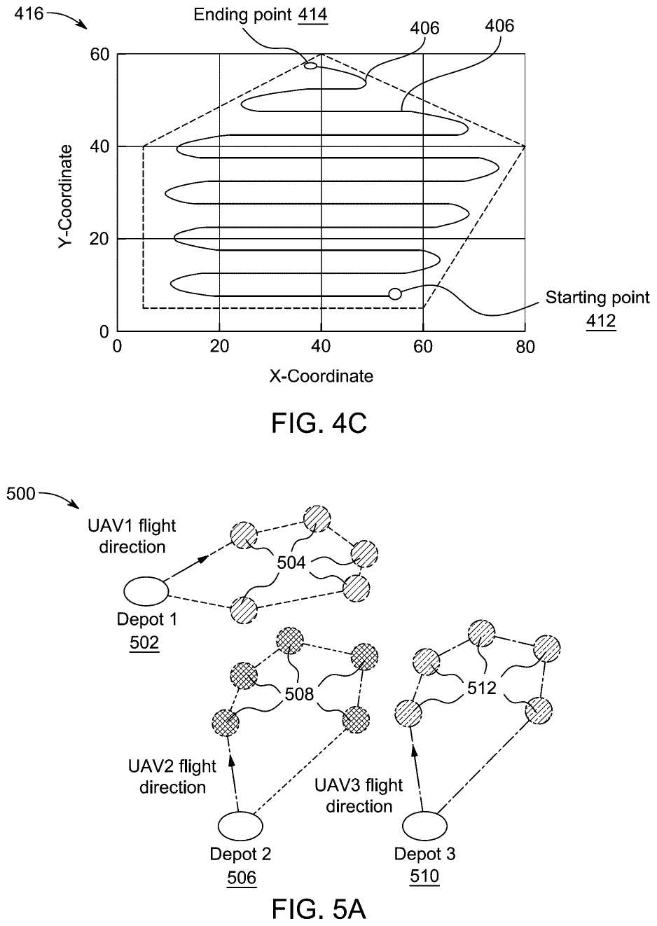

The target region may include no-flying zones (NFZs) or obstacles where the UAV is not allowed to fly during its mission. The UAV is also constrained by its maximum energy consumption. For a successful mission, the UAV would be able to cover the target ROI and return to a depot with minimal energy consumption by finding the shortest trajectory under specific constraints. As such, a search pattern is determined for each region, where the optimal sweep direction is obtained to minimize the number of turns. The theory of optimal sweep direction, along with optimal intra-region path generation, is explained in detail in FIG. 4A

FIG. 4A illustrates an exemplary diagram 400 for computing the optimal line sweep direction 402, according to an embodiment. Since the number of turns equals 2W/FP−2 where W is the width or height of the ROI 404, and FP is the width of the UAV footprint, the region's span is minimized. Therefore, the minimum span of the ROI 404 is obtained when the line sweep direction 402 is perpendicular to one of the edges of the ROI 404. Among all line sweeps drawn from every edge to the farthest vertex of the ROI 404, the optimal line sweep 402 is the one with the shortest distance, and the direction of the line sweep 402 is toward the corresponding vertex of the ROI 404. In this way, the optimal line sweep direction is determined for each ROI 404. This block is represented in the block 110 of FIG. 1A as ‘finding optimal sweep direction of region P’ for the first region of interest 404. Accordingly, the optimal line sweep 402 is the line that minimizes the number of turns of the UAV during the survey. For example, during the actual survey of one ROI, such as ROI 404, each UAV may accelerate, decelerate, take turns, and then accelerate again within the ROI 404 to travel toward the vertex. This cycle repeats until all the POIs within the ROI 404 are covered and the vertex is reached. Therefore, the greater the number of turns in each ROI 404, the higher the energy requirements of the UAV. In other words, the sharper turns there are in a shorter route, the higher the energy consumption. This is because, during a sharp turn, the UAV would decelerate, change direction, and then accelerate several times. A longer route with fewer turns may require less energy. To reduce the number of turns, the optimal direction of the sweep line is selected such that the minimum number of turns is generated. Accordingly, when the UAV travels straight for a longer time without deceleration, avoiding the need to take turns at every next POI and covering a larger number of POIs in a single direction, the UAV encounters turns at the boundary of the region. In other words, the UAV encounters fewer turns when it travels straight for a longer period. As a result, an intra-region path 406 connecting each POI of the plurality of POIs in one direction of travel of the UAV is generated.

After obtaining the optimal line sweep direction 402 and generating the intra-region path 406 that connects each POI of the plurality of POIs in one direction of travel of the UAV, all such paths that cover the entire ROI 404 need to be generated to complete the UAV's path from the starting location to the end location within the ROI 404, i.e., covering the entire ROI 404 during the survey. Accordingly, a layout of the path within the ROI 404 is generated using, for example, a back-and-forth model. This is represented in block 112 in FIG. 1A. The back-and-forth model applies an approach that identifies a set of parallel lines, such as a plurality of flight path lines 406, which connect each POI and cover the entire ROI 404. The span of the region 404 is defined as the distance between the lines of support and the intersection of the terrain at a single edge or vertex. The flight path lines 406 represent the path segments along the direction of the lines of support. The line sweep direction 402 is perpendicular to the flight lines 406. The flight lines 406 also point toward the direction of movement of the UAV during the survey. Clearly, the number of turns depends mainly on the direction of the optimal line sweep 402. The determination of the optimal line sweep direction 402 is crucial to minimize the number of turns. Accordingly, the back-and-forth path pattern 406 is generated for the intra-region paths, i.e., the ROI 404, based on the optimal line sweep direction 402. Therefore, the back-and-forth path 406 pattern determines the optimal line sweep direction perpendicular to a region's edge to minimize the number of turns 408 for multiple ROIs to be surveyed. The generated back-and-forth paths 406 represent a rough intra-region path based on the back-and-forth model in block 112. The rough intra-region path indicates a possible sweep direction of the UAV that connects a plurality of POIs at the time of the actual survey.

With careful observation of FIG. 4A, it is evident that the number of turns occurs at the end boundary of the ROI 404, which helps to reduce energy consumption. As such, the back-and-forth approach minimizes the number of turns for the UAV. However, the back-and-forth model simultaneously generates a plurality of sharp turns 408 at the edges or corners of the ROI 404. These sharp turns lead to unnecessary energy consumption, as the UAV would need to decelerate, make a sharp turn, and then accelerate again. Energy consumption can be further reduced by adjusting the rough intra-region path 406 based on a smoothing turns approach. The smoothing turns approach is described in detail in FIG. 4B.

FIG. 4B illustrates a smoothing turns approach 410 to decrease energy consumption during turning maneuvers of the UAV for a rectangular region of interest, according to an embodiment. The generated rough intra-region path 406 or trajectories are modified using Bezier curves, smoothing the maneuvers along a given path 406, especially at the corners. The mathematical model of Bezier curves is executed in block 114 in FIG. 1A. The smoothing turns approach (STA) modifies the generated rough intra-region path 406 by smoothing the turns at corners along the UAV's trajectory using Bezier curve theory, governed by the following mathematical equation.

$$BZ ( t ) = ( 1 - t ) 2 {P}_{0} + 2 ( 1 - t ) {tP}_{1} + t 2 {P}_{2} ; \qquad ( 1 )$$

where t∈[0 1].

This modification is anticipated to reduce energy consumption while the UAV takes turns at one or more corners during the actual survey. The Bezier curve theory is applied to a rectangular shape, where P0, P1, and P2 represent the control points of the Bezier curve. The starting point 412 indicates the entrance point of the UAV, while the ending point 414 indicates the exit point of the UAV during the actual survey. The smoothing turns approach (STA) therefore minimizes energy consumption during the turning manoeuvres of the plurality of UAVs by using Bezier curves, as in equation (1), to reduce the sharpness of the plurality of turns at corners. Moreover, before the application of the smoothing turns approach, one or more sharp turns at corners cause the UAV to decelerate, change directions, and accelerate multiple times, which increases energy consumption. However, the application of the smoothing turns approach reduces energy consumption by optimizing the deceleration, rotation, and acceleration of the UAV's turning manoeuvres. The plurality of UAVs undergoes less deceleration before reaching the corners, faces less rotation due to the elimination of sharp turns at modified corners, and can continuously accelerate even before reaching the corners.

FIG. 4C illustrates a smoothing turns approach 416 to decrease energy consumption during turning maneuvers of the UAV for a non-rectangular region of interest, according to an embodiment. For a non-rectangular region of interest, the mathematical equation (1) for Bezier curve theory still applies, where the same points P0, P1, and P2 represent the control points of the Bezier curve. The starting point 412 again indicates the entrance point of the UAV, while the ending point 414 indicates the exit point of the UAV at the time of the actual survey when the ROI has a non-rectangular shape.

FIGS. 4A, 4B, and 4C are described with regards to generating paths inside the region of interest (ROI) 216, 300, 404 and applying smoothing curves to the generated paths. The similar process is iteratively repeated for multiple other regions of interest, which multiple UAVs would cover during the actual survey. Accordingly, path generation and the application of smoothing curves are performed for the plurality of ROIs until all ROIs are covered. This block is indicated as block 116 in FIG. 1A. Once the rough intra-region paths 406 are generated and the plurality of corners at turns 408 are adjusted based on the smoothing turns approach, the intra-region energy for each region of interest is calculated.

Now, the intra-region energy required to cover a specific ROI is affected by the path length and the number of turns. The path length is directly proportional to the number of waypoints or POIs as well. The intra-region energy is computed using the equation (2) below:

$${Γ}_{intra} = {\sum }_{p = 1}^{{N}_{r}} ( {\sum }_{i = 1}^{Nl} {\sum }_{k = 1}^{{Nl}_{wp} - 1} E ( k , k + 1 ) + {E}_{turns} ) , \qquad ( 2 )$$

where Nl_{wp} is the number of waypoints in line Ni in region p.

Based on equation (2), the intra-region energy required for each region is determined. The intra-region energy, as described in equation (2), calculates the energy required to travel across all waypoints inside the ROIs. In one embodiment, the intra-region energy for each region may be considered constant.

Moreover, the intra-region energy requirements are also computed based upon takeoff, hovering, cruise, turning, and landing for each intra-region path. For example, the energy consumption in flying vertically of distance h and velocity v_{climb} is calculated as

$${E}_{climb ( h )} = {P}_{climb} \frac{Δ h}{{v}_{climb}} . \qquad ( 3 )$$

The flying vertically down or descent energy for h distance and with velocity v_{desc} is given by

$${E}_{desc} ( h ) = {P}_{desc} \frac{Δ h}{{v}_{desc}} ; \qquad ( 4 )$$

The hovering in place energy from time t1 to time t2 is given by

$${E}_{hover} = {P}_{hover} ( t 2 - t 1 ) . \qquad ( 5 )$$

The flying horizontally is given as a function of velocity and can be given by

$${E}_{horiz} = {P}_{v} \frac{d}{v} \qquad ( 6 )$$

where d is the horizontal distance, and v is the horizontal speed.

The angular speed is assumed to be @turn (2.1 rad/s) and a constant power of Pₜᵤᵣₙ (225 W/s) throughout the rotation. Based on these assumptions, the energy needed to cover an angle θ is calculated as

$${E}_{turn} = {P}_{turn} \frac{Δ θ}{{ω}_{turn}} \qquad ( 7 )$$

Therefore, the overall energy requirements for the specific ROI is written as follows

$$E = {E}_{climb} + {E}_{desc} + {E}_{hover} + {E}_{horiz} + {E}_{turn} \qquad ( 8 )$$

Accordingly, the intra-region energy is computed based upon equation (2) and (8).

An optimal visiting order of all POIs within the ROI is computed, which minimizes equation (2). The lowest value of Γᵢₙₜᵣₐ is identified, at which the intra-region path for each POI in the plurality of POIs is covered within the specific ROI. Similarly, the optimal visiting order of all POIs within other ROIs is computed by minimizing equation (2) and identifying the visiting order of the POIs at which equation (2) is minimized. Accordingly, the intra-region path for each POI in the plurality of POIs is computed to minimize the energy requirement of the one or more UAVs during the survey.

Once the intra-region optimal path is determined for each ROI, the next phase involves solving the inter-region CPP problem using a MILP formulation. This problem is solved using both exact and heuristic approaches to find the best solution. In this phase, an inter-region optimal path is determined that minimizes the total energy consumption of the UAV in covering the travel path between ROIs. In the second phase, each ROI is abstracted into two points: the entry point and the exit point. For example, the entry and exit points of a rectangular ROI are represented by the four vertices of the rectangular shape. The flying energy between each ROI and any other ROI is computed during the intra-region optimal path computation phase. Each UAV is assigned a set of ROIs, and a flight trajectory is determined between the base station and the ROIs, as well as among the other ROIs. To ensure that the UAV safely completes a longer mission, the UAVs periodically return to the base station for refuelling. To determine the optimal path and visiting order of the ROIs, a MILP approach is used, as illustrated in block 118 of FIG. 1A. The MILP is solved using both a heuristic approach (block 120) and an exact approach (block 122) as shown in FIG. 1A.

The main objective of the MILP formulation is to achieve complete coverage of the ROIs while minimizing energy consumption. Thus, the problem is formulated as a minimization optimization problem. A region is assigned to be covered by a UAV if the energy consumption to fly from the current region to the assigned region, along with the energy required for covering the assigned region, is minimized. To model this, a cost function is created that considers the movement of the UAV from a region p to a region q after completing coverage of region p. The energy cost associated with this movement is calculated using the following formula:

$$EnergyCost = {EF}_{tip} {,}_{ejq} + EC , \qquad ( 9 )$$

where EF_{tip,ejq} is the energy consumption to fly from exit point of a region p to entry point of a region q. In an embodiment, energy consumption EF_{tip,ejq} for an inter-region path also depends upon a distance between exit point of a region p and an entry point of a region q.

The EC could be computed using equation (2) according to an embodiment. Then, the objective function of inter-region CPP is represented as below:

$$Obj\_fun = {\sum }_{p = 1}^{N r - 1} E {F}_{p , p + 1} + E {C}_{p + 1} ; \qquad ( 10 )$$

The optimal visiting order of ROI corresponds to the route that minimizes equation (10).

In order to compute intra-region path, certain constraints may be considered to determine one or more optimal paths in between the ROIs that would cover each ROI with minimum energy consumption. Accordingly, an inter-region energy is calculated that would formulate a problem matrix, based upon one or more constraints, such as
1. The drone is allowed to refuel at a base station.
2. Landing and taking off occur at the depot.

Suppose Nr is a number of region of interests (ROIs) (i.e. 1−depot, 2, . . . , Nr) that are required to be covered by Na drones, Ni is the number of lines generated by BAF algorithm inside ROI, dᵢⱼ is a distance from positionᵢ to positionⱼ, Eᵤ is the available energy of a drone u, Eᵢⱼ is the energy consumed to fly from position; to positionⱼ, and can be formulated as follows.

The aim of these constraints is to generate an optimal visiting order of ROIs that minimizes energy consumption. The objective function includes the inter-region energy computation based upon can be calculated as follows:

$${Γ}_{inter} = {\sum }_{p = 1}^{N r} {\sum }_{i = 1}^{{N}_{w p}} {\sum }_{j = 1}^{N w q} E {F}_{\{ i , j \}} * {t}_{\{ upi \}} * {e}_{\{ u q j \}} * {x}_{\{ u pq \}} , \qquad ( 11 )$$

where EF_{i,j} represents a problem matric for computing the energy required to fly from exit point i in region p to enter point j in region q, and q=2, . . . , Nr.

Three decision variables impact the energy required to travel between regions are tᵤₚᵢ, eᵤₚⱼ, and x_{upq} such that the required energy is minimized. The three-decision variable are given as below:

$${t}_{upi} = \{ \begin{matrix}1 , & if a drone u exits region p from position i \\ 0 , & Otherwise\end{matrix} . \qquad ( 12 )$$

$${e}_{uqj} = \{ \begin{matrix}1 , & if a drone u enters region q at position j \\ 0 , & Otherwise\end{matrix} . \qquad ( 13 )$$

$${x}_{upq} = \{ \begin{matrix}1 , & if a drone u flies from region p to region q \\ 0 , & Otherwise\end{matrix} . \qquad ( 14 )$$

tᵤₚᵢ indicates a binary value of either 0 or 1 that depends on the position of the UAV u while exiting a region p. If the UAV u exits from the region p (i.e. a first region) from position i, its value is 1 otherwise 0. This means that if the UAV exits from a one fixed location i, tᵤₚᵢ has value 1 value otherwise value 0. Mathematically it can be expressed using below equation:

$${\sum }_{i = 1}^{Nwp} {t}_{p i} = 1 for all p = 2 , … , {N}_{r} . \qquad ( 15 )$$

Further, e_{uqj} indicates a binary value of either 0 or 1 that depends on the position of the UAV u while entering a region q. If the UAV u enters from the region q (i.e. a second region) from position j, its value is 1 otherwise 0. It means that if the UAV enters from a one fixed location j, e_{uqj} has value 1 value otherwise value 0. Mathematically, this term indicates an entry and exit point of a region constraint that indicates that one entry and exit point for each ROI could be used for minimizing the energy. Mathematically,

$${\sum }_{i = 1}^{N w p} {e}_{p i} = 1 , for all p = 2 , … , {N}_{r} . \qquad ( 16 )$$

Further, x_{upq} also indicates a binary value of either 0 or 1 that depends on the flying path of the UAV u from the first region p to the second region q. This means that if a UAV flies from region p to region q, its value is 1. On the other side, if a drone u flies from region q to region p, its value would be 0. This indicates that the UAV would have a predefined region to cover one after another region in a predefined pattern based upon the minimized energy. Mathematically, this term indicates a sequencing and connectivity of one or more ROI.

The sequencing and connectivity of plurality of ROI is ensured by equation (15) in which each ROI is preceded and succeeded by exactly one other ROI except the depot. The equation (15) also ensures that one UAV flies from region p to region q and once. Mathematically,

$${\sum }_{p = 1}^{N \_ r} {x}_{u p q} = 1 for all q = 2 , … , {N}_{r} , for all u = 1 , … , {N}_{d} . \qquad ( 17 )$$

Based upon equation (15), the energy constraint for the movement of the UAV between regions can be computed that indicates that the UAV is allowed to fly from region p to region q if its energy consumption is sufficient. As such, the energy required for the drone u to travel from region p to region q should be less than drone's available energy. This can be expressed mathematically as below:

$${\sum }_{i = 1}^{N w q} {\sum }_{j = 1}^{N w q} {E}_{tpi , e q j} {x}_{u p q} \leq {E}_{u} , p , q = 1 , … , {N}_{r} . \qquad ( 18 )$$

Apart from the constraints mentioned earlier, other constraints are also considered, such as landing and taking off of UAVs, leading to energy management constraints. This constraint indicates that each UAV departs from and returns to its predefined depot. For example, if a UAV U starts from a depot ‘D’ then upon completion of the mission, the UAV U would return to the depot ‘D’ and not on another depot. In case when the available energy of the UAV U is insufficient to complete the mission, the UAV U would return back to depot ‘D’ for recharging before continuing its task. This means that the drone may need to return to its depot multiple times. Mathematically it can be expressed using below mathematical equation:

$${\sum }_{p = 2}^{{N}_{r}} {x}_{up 1} \geq {N}_{d} {\sum }_{q = 2}^{{N}_{r}} {x}_{u 1 q} \geq {N}_{d} . \qquad ( 19 )$$

Furthermore, an energy sufficient constraint for safe return to the depot is also considered. For example, for a safe return to the depot, equation (20) below indicates that a UAV cannot travel from region p to region q unless the available energy of the UAV is sufficient for both traveling from region p to region q and from region q to the depot. Accordingly, each UAV of the plurality of UAVs is configured to return to a base station or depot for refueling based on a calculated remaining energy reserve during the UAV mission.

Mathematically it is expressed in equation (20) below:

$$0 < {E}_{tpi , e q j} * {X}_{u p q} + {E}_{eqj , 1} \leq {E}_{u} for all p , q = 1 , … , {N}_{r} . \qquad ( 20 )$$

Once, the inter-region energy is computed using the objective function from earlier described equation (10) and considering one or more constraints, the problem matrix is formulated using equation (11) below

$${Γ}_{inter} = {\sum }_{p = 1}^{N r} {\sum }_{i = 1}^{{N}_{wp}} {\sum }_{j = 1}^{Nwq} E {F}_{\{ i , j \}} * {t}_{\{ upi \}} * {e}_{\{ uqj \}} * {x}_{\{ upq \}} , \qquad ( 11 )$$

This block is indicated using block 118 in FIG. 1A.
Furthermore, the problem matrix further includes intra-region energy computation as described earlier in equation (2) as below:

$${Γ}_{intra} = {\sum }_{p = 1}^{{N}_{r}} ( {\sum }_{i = 1}^{N l} {\sum }_{k = 1}^{N {l}_{w p} - 1} E ( k , k + 1 ) + {E}_{turns} ) , \qquad ( 2 )$$

Now the problem matrix includes a summation of the equation (2) and (11) which is created as a mixed integer linear programming (MILP) based formulation in block 118 in FIG. 1A. The MILP based formulation is configured to mathematically determine the optimal trajectory for UAVs from their depots to the target regions and back to their depots while satisfying all constraints for identifying a coverage path for multi-UAV multi-region. Moreover, the concept of refueling multiple UAVs from the depot is incorporated as part of the optimization formulation. Subsequently, the formulated problem is solved using a MILP solver CPLEX as shown by block 122 as well as a heuristic based approaches as shown by block 120, in FIG. 1A, for small- and large-scale region sizes, respectively.

According, by using the heuristic based approach as well as MILP solver CPLEX based approach, the aim is to minimize the summation of intra-region energy and inter region energy, as below:

$${Γ}_{inter} + {Γ}_{intra} \qquad ( 21 )$$

$$i . e . , Min η = {Γ}_{intra} + {Γ}_{inter} ; \qquad ( 22 )$$

Initially, the CPLEX solver was utilized to solve the MILP formulation to minimize the equation (22). The CPLEX solver was utilized for large scale as well as small scale size problem. At the time executing the CPLEX solver, a maximum CPU time limits are imposed to ensure a reasonable computational duration. Based upon the computation by the CPLEX solver, it was identified that the CPLEX solver identifies the best UAV path for small scale size problems. Once the optimal UAV paths are identified by the CPLEX solver, the MILP based formulation are further executed by another approach, i.e., a heuristic approach. The heuristic approach identifies an optimal solution for the path identification and minimizes task completion time.

In both approaches, optimal flight paths are identified that minimizes the equation (22). Once the optimal paths are identified, the block 124 identifies which approach generates less cost function for the optimum flight path. For example, during experimental phase of the invention, it was identified that for short-range problems, CPLEX solver generated the optimum flight path for multiple UAV for multiple regions which generated less cost function. On the other hand, for long-range problems, heuristic approach generated the optimum flight path for multiple UAV for multiple regions which generated less cost function. As such, flight path based on the heuristic approach and the exact approach is determined and it was imperative to select the best flight path for UAV whichever approach generated less cost function. The generated flight path is utilized to configure the flight path of the one or more UAV equipped with the downward-facing imaging device 208 and maintained the fixed altitude during mission operation or survey to cover the predetermined flight path, which minimizes the energy consumption of the one or more UAVs.

At block 126 the method 100 terminates.

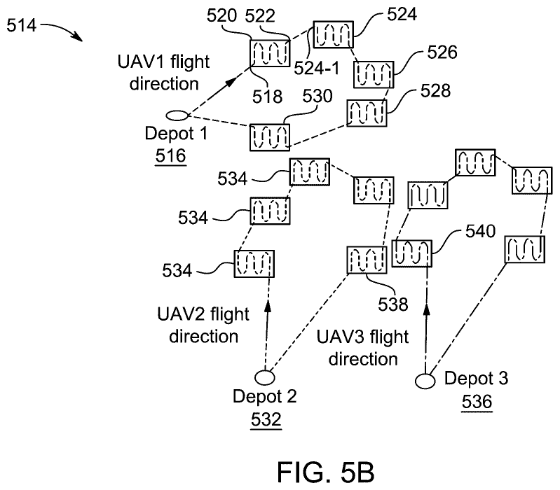

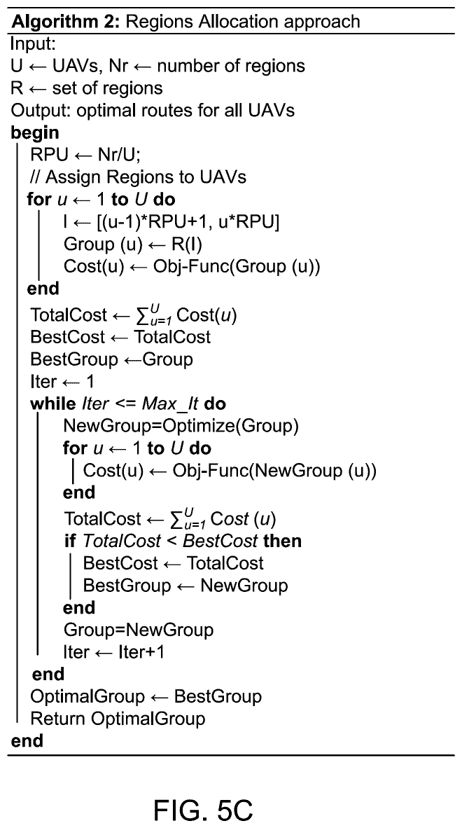

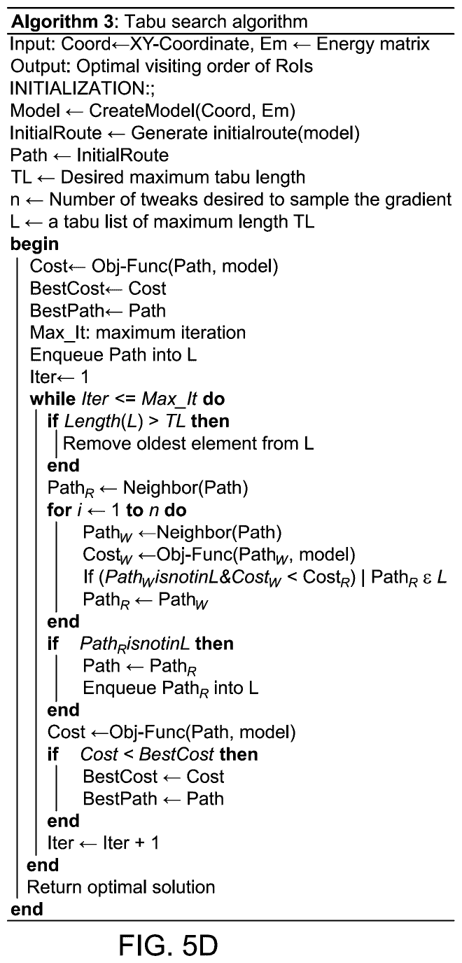

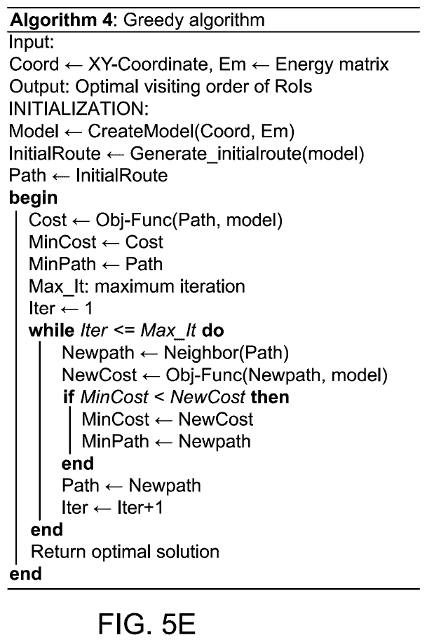

In an embodiment, when the number of regions is more than one, for example 15 and the number of UAV are, for example 3, the one or more regions may be grouped together. As such a region allocation optimization approach is further utilized to further reduce the energy consumption of plurality of UAV by assigning the plurality of regions to the plurality of UAVs based on starting positions of the plurality of UA Vs and energy capacities of the plurality of UAVs. This is explained in detail in FIGS. 5A and 5B.

FIG. 5A illustrates an environment 500 for computation of optimal group and visiting orders for a plurality of regions 504, 508, 512 by multiple UAVs 502, 506, and 510, according to an embodiment. For example, the environment 500 includes the plurality of regions such as region 504, 508 and 512. The environment further includes multiple UAVs 502, 506 and 510. Therefore, the plurality of ROI are divided into three groups, as illustrated into FIG. 5A.

In multiple regions 504, 508, 512 and multiple UAVs 502, 506, 510, the one or more regions 504, 508, 512 may be effectively grouped into U groups to form a cluster depending on the available number of UAV. In another embodiment, the one or more regions 504, 508, 512 may also be effectively grouped into U groups to form the cluster depending on the spatial distribution of the one or more regions 504, 508, 512. Accordingly, the total number of regions needs to be optimally divided among available number of UAVs that are available for the mission or the survey, such that the best visiting order that minimizes energy consumption is found for each UAV.

Further, the one or more UAVs may be located at different depots, and the groups of regions are allocated to appropriate UAVs. Therefore, best groups of regions are identified during region allocation that UAVs can cover so that the required energy is minimal. In order to identify the best visiting order of the ROI, and the total energy consumption to be minimized, a meta-heuristic approach is again utilized for region assignment to effectively obtain the optimal allocation of regions to multiple UAVs, for reducing overall energy consumption. At this time, region allocation approach executes the following Algorithm 2 in, for example, the processing device (not shown), such as the laptop, desktop, mobile, cellphones or alike, as discussed earlier in FIG. 1A. Algorithm 2 is illustrated in FIG. 5C and briefly described herein.

FIG. 5C illustrates Algorithm 2 for applying a region allocation approach effectively, according to an embodiment. Algorithm 2 is configured to accept multiple inputs, such as the number of regions, the set of regions, the number of UAVs, etc. The output of Algorithm 1 is the energy-efficient trajectory or paths for one or more UAVs across one or more regions. During the execution phase of Algorithm 2, multiple processes are again carried out. These processes include dividing number of regions with the available number of UAVs, forming group of regions, identifying cost of the objective function, selecting the best cost and selecting the best group of UAVs that minimizes the energy consumption. The brief description of Algorithm 2 is introductory only. Each individual process is described in detail in FIG. 5A.

Referring back to FIG. 5A, initially, the algorithm accepts the total number of UAVs 502, 206, and 510 as well as a number of regions, i.e., 15 regions, for example. The group of the regions may be formed using the mathematical equation below:

$$Region i = [ \frac{{N}_{r}}{U} * ( i - 1 ) + 1 to \frac{{N}_{r}}{U} * i ] ; \qquad ( 23 )$$

The mathematical equation (23) is executed in the Algorithm 2 and initially randomly forming group of the region. For example, one of the groups may include 4 regions associated with the deport1 (green colour) and one region associated with the deport2 (yellow colour), another group may include 4 regions associated with the deport2 (yellow colour) and one region associated with the deport1 (green colour). The third group may include all 5 regions associated with the deport3 (blue colour). In a similar way, multiple groups of different regions may be developed. For each group, the meta-heuristic approach computes the objective function as explained earlier in equation (10) and again provided below:

$$Obj\_fun = {\sum }_{p = 1}^{N r - 1} {EF}_{p , p + 1} + {EC}_{p + 1} . \qquad ( 10 )$$

Further, the cost of the objective function is computed. Whichever group of regions generate a less cost, that group of regions are considered as a set of groups for UAV 502. Similarly, a group of regions are also formed for UAV 506 as well as UAV 510. After determining groups of regions, the coordinates of one or more ROI in different groups are optimized by Optimize (Group) function of the Algorithm 2, which describes a swapping and crossover between different groups so that the overall energy cost is minimized. At the end of iterations, each UAV is assigned to the best group of ROIs that minimizes the overall energy consumption.

FIG. 5B illustrates a two-dimensional view 514 of multi-UAV and multi-region coverage path planning for three UAVs, according to an embodiment. Based upon the heuristic approach, the optimal visiting order of ROIs is obtained for each group. The optimal visiting order of the ROIs is determined. The exact solution would achieve the optimum trajectory of the UAV by exhaustively exploring the solution space. However, this comprehensive search becomes impractical for large-scale and complex system problems due to the exponentially increasing solution space and the associated time consumption. To cater this problem in a more efficient manner in the context of largescale cooperative real path planning scenarios, a tabu search as well as a greedy search is used. The tabu search Algorithm 3 and the Greedy search algorithm are illustrated in FIGS. 5D and 5E, respectively, and briefly described herein.

FIG. 5D illustrates Algorithm 3 for executing the tabu search, according to an exemplary embodiment. Algorithm 3 is configured to accept multiple inputs, such as the XY coordinate of the region, energy matrix, etc. The output of Algorithm 3 is an optimal visiting order of the one or more ROI. During the execution phase of Algorithm 3, multiple processes are again carried out. These processes include model creation, initial route generation, identification of tabu length and a tabu list, determination of a cost function, determination of best path and return optimal solution. Broadly, the Tabu search approach obtains the optimal visiting order of one or more ROI considering a tabu size. To optimize the problem matrix, the tabu search examines a solution sampling of the neighborhood and retains the best solution nearby, even if its quality is worse than the current solution, to avoid sticking to a local optimum.

FIG. 5E illustrates Algorithm 4 for executing a Greedy search, according to an exemplary embodiment. Algorithm 4 is also configured to accept multiple inputs, such as the XY coordinate of the region, energy matrix, etc. The output of Algorithm 3 is an optimal visiting order of the one or more ROI. During the execution phase of Algorithm 4, multiple processes are again carried out. These processes include model creation, initial route generation, objective function determination, neighbor path determination, determination of best path and return optimal solution. Broadly, the Greedy search identifies the optimal order of visiting the one or more ROI for finding a local optimum at each iteration. In this algorithm, at each step, the algorithm chooses the option that appears to be the best at that moment, without considering the potential future consequences. As such, at each stage a solution is built block by block by selecting the best available choice at each stage.

Referring back to FIG. 5B, based upon execution of Algorithm 3 and Algorithm 4, an optimum flight path is determined that depends upon the number of UAVs of the plurality of UAVs for example 15 in the considered example, the intra-region energy Γᵢₙₜᵣₐ, and the inter-region energy Γᵢₙₜₑᵣ. For example, in FIG. 5B, the optimal flight path for UAV 1 includes a flight direction that begins from the depot1 516, towards a determined entry point 518 of the first ROI 520 which minimizes the cost function in equation (10) and applying the BAF algorithm and applying the smoothing curve to smooths the curves of the ROI 520 and exits the first ROI 520 from a determined exit point 522 which again minimizes the cost function in equation (10) and proceeds towards the next ROI 524 from the entry point 524-1. The survey process continues till all other ROI i.e. 526, 528 and 520 are covered. Once the UAV 1 completes the survey, the UAV 1 return to the deport1 516. The similar process is repeated for UAV 2 located at depot2 532 to cover the multiple ROI i.e. ROI 534 and return to the deport2 532. The similar process is repeated for UAV 3 located at depot3 536 to cover the multiple ROI i.e. ROI 538 and return to the deport3 536.

In an embodiment, the determined flight path based upon the tabu search and the greedy search algorithm, an overlap between the paths of one or more UAV are minimized while surveying the one or more ROI due to adjacent flight paths. For example, in FIG. 5B, the optimum path determined for UAV 2 at depot2 523 and UAV 3 at depot3 536 covers the adjacent ROI 538 and ROI 540, respectively. The path calculation for UAV 2 and UAV 3 using multiple equations that minimize the overall cost function determines that the ROI 538 and ROI 540 may be located near each other; however, they are not overlapping. Therefore, the UAV energy is minimized, for example, by not surveying the ROI 540 by the UAV2 and surveying the ROI 538 by the UAV 3, simultaneously. Therefore, overlapping avoidance improves the overall energy efficiency of the one or more UAV at multiple depot locations.

In an embodiment, the determined flight path may be updated based upon the detection of one or more environmental changes. For example, in FIG. 5B, some environmental changes are detected, such as changes in weather conditions, rain, fog, mist, typhoon, weather tribulation, or the like, in the ROI 524 for the first UAV 1, whereas the ROI 520 and 526 are clear for the survey. The environmental changes may be detected based upon plurality of weather sensors (not shown) at each ROI 520, 524, 526, 528 and 520 and the depot1 516. Weather sensors (not shown) may be configured to periodically communicate the weather information to, for example, the depot1 516. Based upon updates from the weather sensor at the depot1 516, the flight path for the UAV 1, for example, may be updated. In this case, the UAV 1 may be reconfigured with a new path which covers the ROI 520 followed by ROI 526, thereby skipping the survey of ROI 526. The ROI 524 may be exemplary considered to have changes in environmental condition. However, other ROIs may have also detected changes in the environmental conditions, such as ROI 526, 528, or 530. In this case, the flight path may be updated so that UAV 1 skips surveying ROI 526, 528, or 530 in between and returns to the base station or Depot 1 (516) after completing the survey for ROI 520 and 524.

In another embodiment, the determined flight path maximizes continuous UAV communication with the base station or the depot. For example, the UAV, for example UAV 1 in FIG. 5 is also configured to compute a remaining energy reserve for the rest of the survey of the ROI, for example, ROI 528 and 530. Meanwhile, the UAV 1 identifies that it needs refueling due to, for example, overconsumption due to faded scanning at a few POIs of one of the ROIs, for example, ROI 524. At this time, the determined flight path may again be updated. The UAV 1 may be reconfigured to return to a base station or depot for refueling. At this time, the UAV 1 may maintain continuous communication with the base station or the depot1 516 to provide updates on the remaining energy reserve in the UAV 1. As such, the determined flight path may again be updated to maximize continuous UAV communication with the base station or the depot1 516.

### Examples

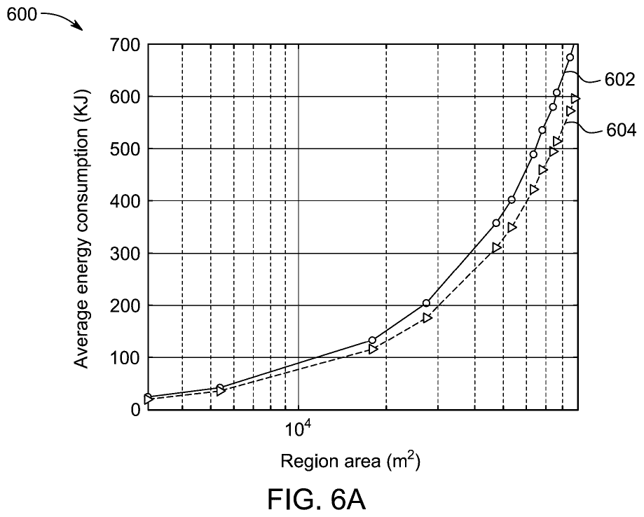

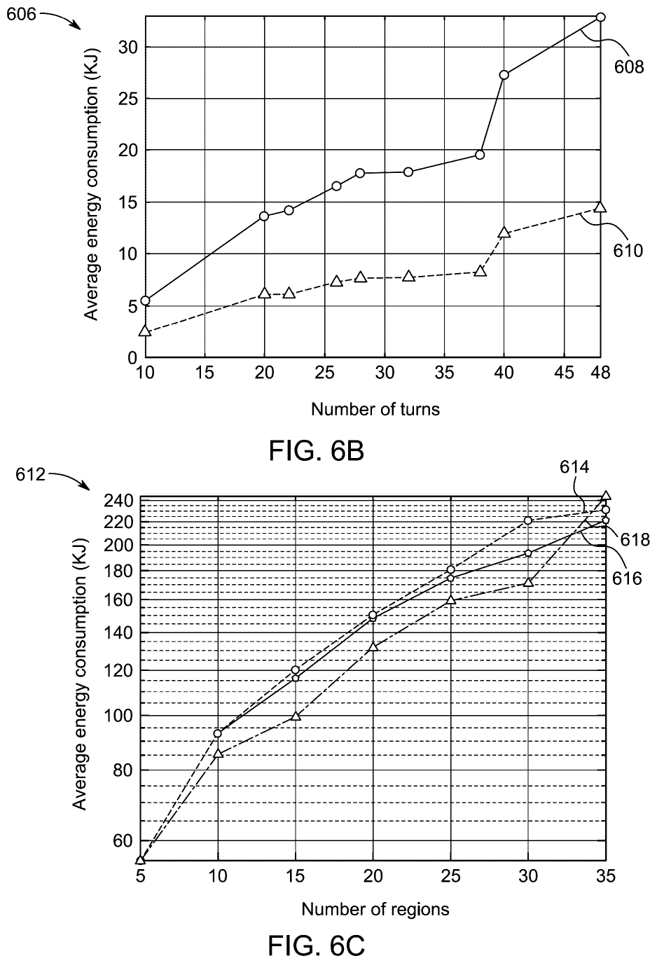

FIG. 6A illustrates an Intra-region CPP performance graph 600 for analyzing the average energy consumption with respect to region size, according to an embodiment. The evaluation of the performance of the multi-UAV multi region algorithm was identified based upon the energy consumption of the algorithm. For evaluation of the energy consumption, a single drone was used to assess the intra region CPP performance. The UAV was configured to fly from the depot, covering every waypoint and return. A back-and-forth strategy way applied with optimal line sweep direction to minimize the number of turns. The STA was further applied to reduce energy consumption due to turning. It was obvious that the energy consumption goes up simultaneously with an increase in region size, demonstrating the effect of problem size on energy consumption. The higher the number of sharp turns in a shorter route, the more the energy consumption. This is because, in a sharp turn, the UAV may have to decelerate, change directions, and accelerate several times. For this reason, smoothing the turn reduces the energy consumption for taking a turn. A curve 602 indicates actual energy consumption with respect to the region area when back-and-forward strategy was applied over the path of the UAV. On the other hand, the average consumption energy reduced considerably when both back-and-forth as well as smoothing curve algorithm was applied on the path of the UAV for the same region area, which is indicated by a curve 604. It was evident from both curves that smoothing turn algorithm (STA) considerably reduces the energy consumption for survey of the region (ROI). This gap increases as a region size increases. It is imperative to conclude that increasing region size may increase the number of turns that consumes significant energy and the STA reduces the energy required by sharp turns.

FIG. 6B illustrates an Intra-region CPP performance graph 606 for analyzing the average energy consumption with respect to the number of turns, according to an embodiment. A curve 608 indicates the average energy consumption with respect to the number of turns when back-and-forward approach was applied to find the path of a UAV, whereas a curve 610 indicates the average energy consumption with respect to the number of turns when both back-and-forward approach and the smoothing turn approach was applied to find the path of the UAV. It was experimentally observed that the energy consumption was significantly improved as the number of turns increases when applying the smoothing turn approach. Additionally, a gap improvement in energy consumption was obtained. The Gap percentage represents the gap between the curves 608 and 610 by applying the back-and-forward approach and back-and-forward approach and smoothing turn approach. Mathematically, the gap percentage may be represented by equation (24) as below.

$$Imp . Gap percentage \% = \frac{EBS - EAS}{EBS} ; \qquad ( 24 )$$

where,
EBS=Energy of back-and-forward approach without applying the smoothing turn,
EAS=Energy after applying the smoothing algorithm.

It was experimentally found that the percentage gap reaches up to 27.78% improvement. Also, the results of the gap percentage were recorded in Table 1.

TABLE 1
The improvement gap percentage statistics of the smoothing
turns approach for different region sizes

| NoWPs | BAF | BAF + SA | Improvement Gap % |
|---|---|---|---|
| 10 | 18860 | 15770 | 16.38388 |
| 20 | 27140 | 19600 | 27.78187 |
| 22 | 45040 | 38550 | 14.40941 |
| 24 | 44260 | 34990 | 20.94442 |
| 26 | 68250 | 58210 | 14.71062 |
| 28 | 45890 | 37820 | 17.58553 |
| 32 | 70570 | 60330 | 14.51042 |
| 38 | 91080 | 79780 | 12.40668 |
| 40 | 87320 | 71990 | 17.55612 |
| 48 | 153200 | 134790 | 12.01697 |

FIG. 6C illustrates an Inter-region CPP performance curve 612 for analyzing the performance of a single UAVs multiple disjoint regions, according to an embodiment. The performance of the inter-regions CPP approach was investigated based on optimality. Different simulations were designed to demonstrate the optimality of the Inter-region CPP performance. In a first scenario, the number of regions were varied from 5 to 35 different regions, randomly distributed throughout the environment. The inter-region CPP problem was formulated based on MILP and solved using a CPLEX solver, and approximate solution based on heuristics. In the second simulation scenario, the number of regions was set to 30 ROIs, while the number of UAVs varied from 2 to 5 UAVs. Based upon this data, the region allocation optimization was evaluated. We study and evaluate the impact of the maximum energy capacity of drones on energy consumption in all scenarios. The following subsections will discuss the performance of the inter-regions CPP approach was evaluated considering multiple ROIs by a single UAV. Curves 614, 616 and 618 indicates average energy consumption with respect to the number of regions using tabu search, greedy search and MILP based search, respectively. It was experimentally observed that as the number of regions increases, the average energy consumption increases for all approaches. Comparing tabu search to the greedy algorithm, tabu search coverage path was observed to consume less energy but still more than the CPLEX solver coverage path, which has the lowest energy consumption. However, the CPLEX coverage path shows the worst performance for larger problem sizes due to the exponential increase in the solution space, leading to inefficiencies in time consumption. If a UAV is unable to complete the mission in one trip due to insufficient energy, the UAV can return to the base station for recharging. The drone can fly from region p to region q if its available energy covers both the journey from region p to region q and from region q to the depot. This constraint enables the generation of a safe path with minimal energy consumption.

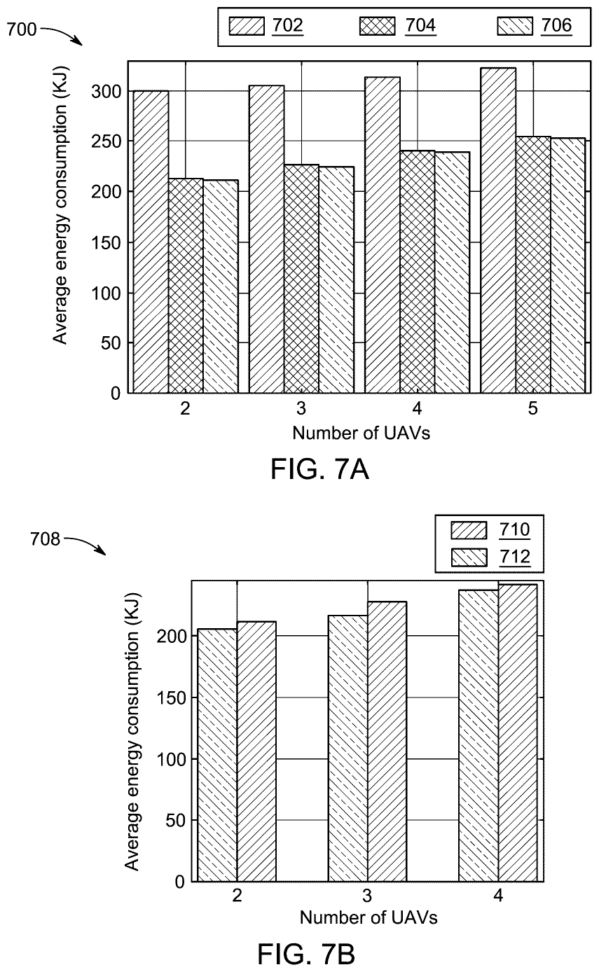

FIG. 7A illustrates an Inter-region CPP performance statistic 700 for analyzing the performance of a multiple UAVs multiple disjoint regions using Greedy search, Tabu search, and MILP based search, according to an embodiment. For this analysis, available number of UAVs were varied from 2 to 5, and the number of ROI were grouped based on available UAVs into 2, 3, 4, and 5 groups. Each drone was provided with a mission to cover a set of ROIs. The multi-UAV was employed when the number of regions is large, and a single UAV cannot fully cover by due to limited onboard battery power. The one or more UAV initiates their flight from the depot, covering a set of ROI, and eventually returns to the depot. The sequence in which the ROIs were visited is selected such that the overall energy consumption is minimized. Curves 702, 704 and 706 indicates average energy consumption with respect to the number of UAV using Greedy search, Tabu search, and MILP based search, respectively. It was experimentally observed that as the number of UAVs increases, the energy consumption of all three methods also increases. However, the CPLEX solver exhibited lower energy consumption compared to the tabu search, while the greedy algorithm showed the highest energy consumption. This energy consumption gap widens with an increasing number of UAVs due to that fact that each UAV needs to fly from its respective depot and return to the depot. Furthermore, the greedy algorithm, while seeking a locally optimal solution, fell short in finding a globally optimal solution due to its short-term decision-making approach. Consequently, the greedy algorithm generated sub-optimal solutions with no guarantee of achieving the globally optimal solution. On the other hand, the CPLEX solver achieved the best solution for the plurality of UAVs by thoroughly exploring the entire solution space.

FIG. 7B illustrates an Inter-region CPP performance statistic 708 for analyzing the effect of region allocation optimization in conserving energy of multiple UAVs multiple disjoint regions, according to an embodiment. For the analysis of energy conservation, 30 regions were grouped into 2, 3, and 4 groups for 2, 3, and 4 UAVs, respectively. Curves 710 and 712 indicate average energy consumption with respect to the number of UAV when region allocation optimization was not applied and when region allocation optimization was applied, respectively. It was experimentally observed that region allocation optimization enhanced the overall energy consumption by optimally assigning the ROI groups to appropriate number of UAV.

Furthermore, a simulation of plurality of UAVs was also executed to determine the impact of maximum energy capacity of the one or more UAV on the number of UAVs required to complete the task and overall energy consumption to complete the CPP mission or survey. In this to perform the simulation, six different ROIs were utilized to perform a multiple UAVs multiple regions CPP simulation, and the results were recorded in Table 3. Results show that the amount of required energy consumption decreases as the maximum capacity of energy increases and the number of UAVs needed to complete a given mission or survey decrease.

TABLE 2
Effect of maximum energy capacity of UA Vs on energy
consumption and required UAVs to complete the mission

| Max | | | | | | | Number |
|---|---|---|---|---|---|---|---|
| Capacity | | | | | | Total | of |
| (KJ) | UAV1 | UAV2 | UAV3 | UAV4 | UAV5 | Energy | UAVs |
| 25 | 3.38766 | 9.90472 | 20.1453 | 4.11452 | 17.6342 | 55.1864 | 5 |
| 30 | 3.38766 | 22.0365 | 6.04567 | 23.0439 | | 54.5138 | 4 |
| 35 | 17.5555 | 9.80472 | 24.14.3 | | | 51.5005 | 3 |
| 40 | 16.2788 | 35.1425 | | | 51.4213 | 2 | |
| 80 | 51.0253 | | | | 51.0253 | 1 | |

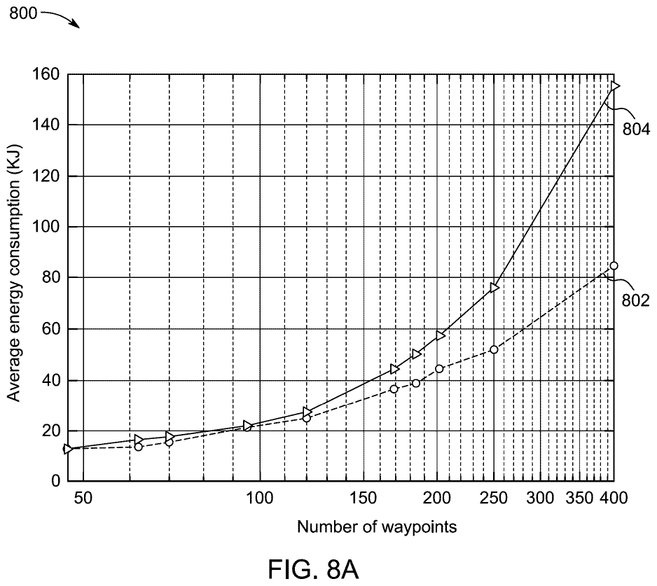

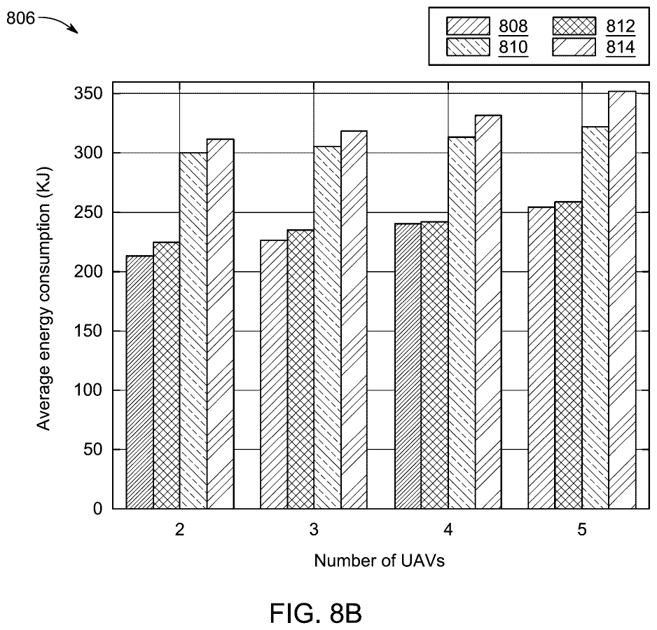

FIG. 8A illustrates an average energy consumption curve 800 with respect to number of way points for intra-region CPP performance, according to an embodiment. Curves 802 and 804 indicates the average energy consumption with respect to number of way points for the current invention and a simulated annealing based approached in the prior art, respectively. It was experimentally observed that as a region size increases, the energy consumed by UAV to cover it also increases. The current approach performs better then EECPPA in terms of energy consumption, especially, when the region size increases. For small region sizes, in which the number of turns generated by the EECPPA is less than the Back-and-forward approach, EECPPA showed better results. However, for large regions, the current invention indicated a less energy consumption than the EECPPA with an improvement gap of up to 45% for 400 waypoints. This implies that the current invention has potential to identify better paths in terms of energy consumption minimization due to smoothing turns that reduces the energy consumption during turns. Furthermore, when considering a turn energy consumption, the route of the intra-region has less turn effect than simulated annealing approach in the art in most regions, especially in large region sizes. As a result, the overall energy consumption became less than simulated annealing approach in the art. Also, the cruise, turning, and total energy consumption were calculated, and results are reported in Table 3.

TABLE 3
Effect of intra-region CPP algorithm of the disclosure
and simulated annealing (SA) approach on energy
consumption for different region sizes

| | | Cruise | Turning | Total | Improvement |
|---|---|---|---|---|---|
| NoWPs | Approach | Energy | Energy | Energy | Gap % |
| 47 | Disclosure | 7669 | 2174.8 | 12844 | −37.575 |
| | SA | 6384 | 2951.4 | 9336 | |
| 48 | Disclosure | 7923 | 1971.9 | 9895 | 8.345684 |
| | SA | 7388 | 3409.3 | 10796 | |
| 62 | Disclosure | 10858.9 | 1973.83 | 12832.5 | 22.41536 |
| | SA | 10411 | 6129.4 | 16540 | |
| 70 | Disclosure | 11031 | 4648.8 | 15679 | −6.98008 |
| | SA | 10271 | 4385.4 | 14656 | |
| 95 | Disclosure | 16608 | 4753.4 | 21361 | −11.1973 |
| | SA | 14383 | 4828.4 | 19210 | |
| 115 | Disclosure | 18740 | 6244.1 | 24985 | 1.788522 |
| | SA | 18032 | 7408 | 25440 | |
| 120 | Disclosure | 20260 | 4340.6 | 24600 | 10.15996 |
| | SA | 19835 | 7545.3 | 27382 | |
| 169 | Disclosure | 31202 | 5111.8 | 36313 | 18.01084 |
| | SA | 31481 | 12811.4 | 44290 | |
| 184 | Disclosure | 31901 | 6629.3 | 38530 | 23.14903 |
| | SA | 35953 | 14180.3 | 50136 | |
| 202 | Disclosure | 36536 | 7856.3 | 44392 | 22.70511 |
| | SA | 41762 | 15668.6 | 57432 | |
| 250 | Disclosure | 43625 | 8162.4 | 51787 | 31.96127 |
| | SA | 55690 | 20424.7 | 76114 | |
| 400 | Disclosure | 75294 | 9470.3 | 84764 | 45.46554 |
| | SA | 116291 | 39139.6 | 155432 | |

FIG. 8B illustrates an average energy consumption curve 806 with respect to number of UAV for plurality of optimal path determination approach, according to an embodiment. The current invention and Nearest Neighbor based approach (NN) were applied to group the ROIs into 2, 3, 4, and 5 groups. A tabu search and greedy approaches were applied to find the optimal visiting order of ROIs. Curves 808, 810, 812 and 814 indicate the average energy consumption with respect to number of UAVs using a TABU search based approach of the current invention, Greedy search, Nearest neighbor based tabu search and a Nearest neighbor Greedy search algorithm, respectively. It was experimentally observed that as a region, the tabu search in the current invention generated more energy-effective path because ROIs were grouped and optimized so that the overall energy consumption was minimized. Each UAV was assigned to the most appropriate group of ROIs and offers a shorter path than Nearest neighbor (NN) based search.

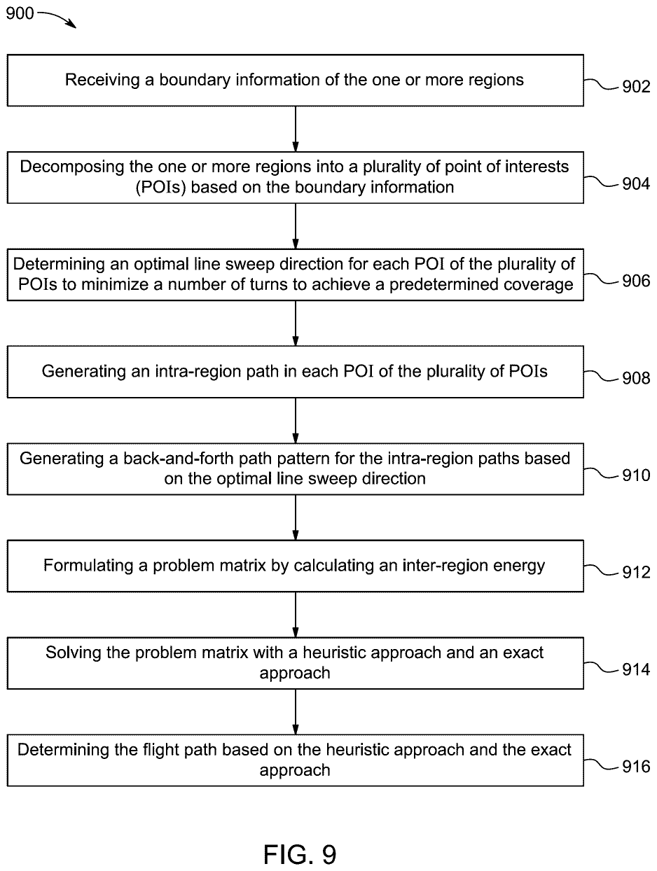

FIG. 9 illustrates a flowchart of a method 900 of planning a flight path of a plurality of unmanned aerial vehicles (i.e. UAV 1, UAV 2 and UAV 3) over one or more regions, according to an embodiment. The method 900 is described in conjunction with FIGS. 1-5, and plurality of experimental results in FIGS. 6-8. Various steps of the method 900 are included through steps in FIG. 9. One or more steps may be combined or eliminated to achieve the objective of method of planning the flight path of a plurality of unmanned aerial vehicles (i.e. UAV 1, UAV 2 and UAV 3) over one or more regions, without departing from the scope of the present disclosure.

At block 902, the method 900 includes receiving a boundary information 216, 302 of the one or more regions of interest 214, 300.

At block 904, the method 900 further includes decomposing the one or more regions of interest 214, 300 into a plurality of point of interests (POIs) 306 based on the boundary information 216, 302.

At block 906, the method 900 further includes determining an optimal line sweep direction 402 for each POI of the plurality of POIs 306 to minimize a number of turns 408 to achieve a predetermined coverage.

At block 908, the method 900 further includes generating an intra-region path 406 in each POI of the plurality of POIs 306.

At block 910, the method 900 further includes generating a back-and-forth path pattern 406 for the intra-region paths based on the optimal line sweep direction 402.

At block 912, the method 900 further includes formulating a problem matrix by calculating an inter-region energy.

At block 914, the method 900 further includes solving the problem matrix with a heuristic approach and an exact approach.

At block 916, the method 900 further includes determining the flight path based on the heuristic approach and the exact approach.

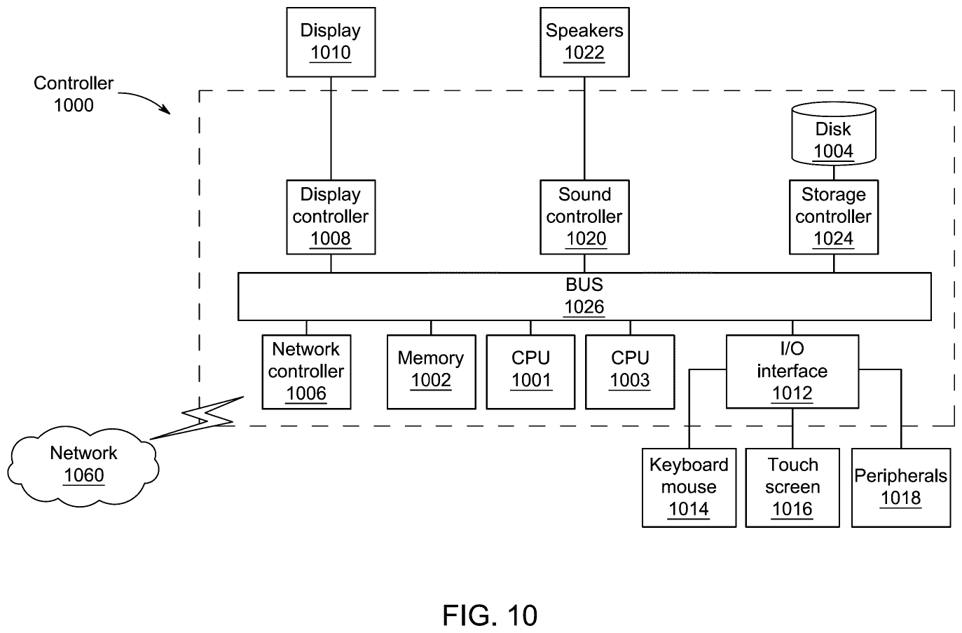

Next, further details of the hardware description of the computing environment according to exemplary embodiments is described with reference to FIG. 10. In FIG. 10, a controller 1000 described is representative of the processing device such as a laptop, desktop, mobile phone, cellphone, or similar, capable of processing the Algorithm 1, Algorithm 2, Algorithm 3 and Algorithm 4. Each algorithm is configured for executing the method of planning flight path of plurality of unmanned aerial vehicles (UAVs) over plurality of regions to entirely cover plurality of separated regions to minimize the overall energy consumption of the one or more UAVs as illustrated in FIG. 1A. The controller 1000 is a computing device which includes a CPU 1001 which performs the processes described above/below. The process data and instructions may be stored in memory 1002. These processes and instructions may also be stored on a storage medium disk 1004 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 1001, 1003 and an operating system such as Microsoft Windows 7, Microsoft Windows 10, Microsoft Windows 11, UNIX, Solaris, LINUX, Apple MAC-OS, and other systems known to those skilled in the art.

The hardware elements in order to achieve the computing device may be realized by various circuitry elements, known to those skilled in the art. For example, CPU 1001 or CPU 1003 may be a Xenon or Core processor from Intel of America or an Opteron processor from AMD of America, or may be other processor types that would be recognized by one of ordinary skill in the art. Alternatively, the CPU 1001, 703 may be implemented on an FPGA, ASIC, PLD or using discrete logic circuits, as one of ordinary skill in the art would recognize. Further, CPU 1001, 703 may be implemented as multiple processors cooperatively working in parallel to perform the instructions of the inventive processes described above.

The computing device in FIG. 10 also includes a network controller 1006, such as an Intel Ethernet PRO network interface card from Intel Corporation of America, for interfacing with network 1060. As can be appreciated, the network 1060 can be a public network, such as the Internet, or a private network such as an LAN or WAN network, or any combination thereof and can also include PSTN or ISDN sub-networks. The network 1060 can also be wired, such as an Ethernet network, or can be wireless such as a cellular network including EDGE, 3G, 4G and 5G wireless cellular systems. The wireless network can also be Wi-Fi, Bluetooth, or any other wireless form of communication that is known.

The computing device further includes a display controller 1008, such as a NVIDIA Geforce GTX or Quadro graphics adaptor from NVIDIA Corporation of America for interfacing with display 1008, such as a Hewlett Packard HPL2445w LCD monitor. A general purpose I/O interface 1012 interfaces with a keyboard and/or mouse 1014 as well as a touch screen panel 1016 on or separate from display 1010. General purpose I/O interface also connects to a variety of peripherals 1018 including printers and scanners, such as an OfficeJet or DeskJet from Hewlett Packard.

A sound controller 1020 is also provided in the computing device such as Sound Blaster X-Fi Titanium from Creative, to interface with speakers/microphone 1022 thereby providing sounds and/or music.

The general-purpose storage controller 1024 connects the storage medium disk 1004 with communication bus 1026, which may be an ISA, EISA, VESA, PCI, or similar, for interconnecting all of the components of the computing device. A description of the general features and functionality of the display 1010, keyboard and/or mouse 1014, as well as the display controller 1008, storage controller 1024, network controller 1006, sound controller 1020, and general purpose I/O interface 1012 is omitted herein for brevity as these features are known.

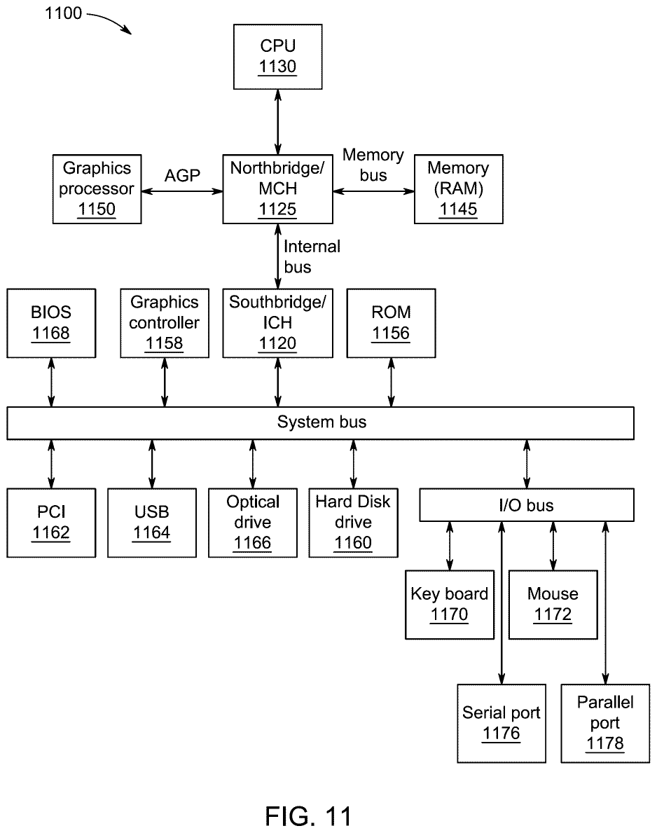

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 11.

FIG. 11 shows a schematic diagram of a data processing system 1100, according to certain embodiments, for performing the functions of the exemplary embodiments. The data processing system 1100 is an example of a computer in which code or instructions implementing the processes of the illustrative embodiments may be located.

In FIG. 11, data processing system 1100 employs a hub architecture including a north bridge and memory controller hub (NB/MCH) 1125 and a south bridge and input/output (I/O) controller hub (SB/ICH) 1120. The central processing unit (CPU) 1130 is connected to NB/MCH 1125. The NB/MCH 1125 also connects to the memory 1145 via a memory bus, and connects to the graphics processor 1150 via an accelerated graphics port (AGP). The NB/MCH 1125 also connects to the SB/ICH 1120 via an internal bus (e.g., a unified media interface or a direct media interface). The CPU Processing unit 1130 may contain one or more processors and even may be implemented using one or more heterogeneous processor systems.

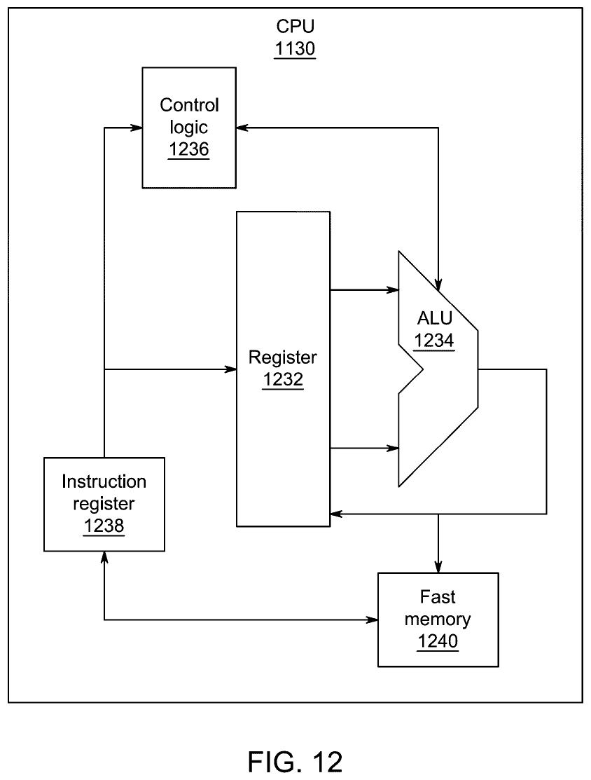

For example, FIG. 12 shows one implementation of CPU 1130, according to an embodiment. In one implementation, the instruction register 1238 retrieves instructions from the fast memory 1240. At least part of these instructions is fetched from the instruction register 1238 by the control logic 1236 and interpreted according to the instruction set architecture of the CPU 1130. Part of the instructions can also be directed to the register 1232. In one implementation, the instructions are decoded according to a hardwired method, and in another implementation, the instructions are decoded according to a microprogram that translates instructions into sets of CPU configuration signals that are applied sequentially over multiple clock pulses. After fetching and decoding the instructions, the instructions are executed using the arithmetic logic unit (ALU) 1234 that loads values from the register 1232 and performs logical and mathematical operations on the loaded values according to the instructions. The results from these operations can be feedback into the register and/or stored in the fast memory 1240. According to certain implementations, the instruction set architecture of the CPU 1130 can use a reduced instruction set architecture, a complex instruction set architecture, a vector processor architecture, a very large instruction word architecture. Furthermore, the CPU 1130 can be based on the Von Neuman model or the Harvard model. The CPU 1130 can be a digital signal processor, an FPGA, an ASIC, a PLA, a PLD, or a CPLD. Further, the CPU 1130 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 11, the data processing system 1100 can include that the SB/ICH 1120 is coupled through a system bus to an I/O Bus, a read memory (ROM) 1156, universal serial bus (USB) port 1164, a flash binary input/output system (BIOS) 1168, and a graphics controller 1158. PCI/PCIe devices can also be coupled to SB/ICH 888 through a PCI bus 1162.

The PCI devices may include, for example, Ethernet adapters, add-in cards, and PC cards for notebook computers. The Hard disk drive 1160 and CD-ROM 1166 can use, for example, an integrated drive electronics (IDE) or serial advanced technology attachment (SATA) interface. In one implementation the I/O bus can include a super I/O (SIO) device.

Further, the hard disk drive (HDD) 1160 and optical drive 1166 can also be coupled to the SB/ICH 1120 through a system bus. In one implementation, a keyboard 1170, a mouse 1172, a parallel port 1178, and a serial port 1176 can be connected to the system bus through the I/O bus. Other peripherals and devices that can be connected to the SB/ICH 1120 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

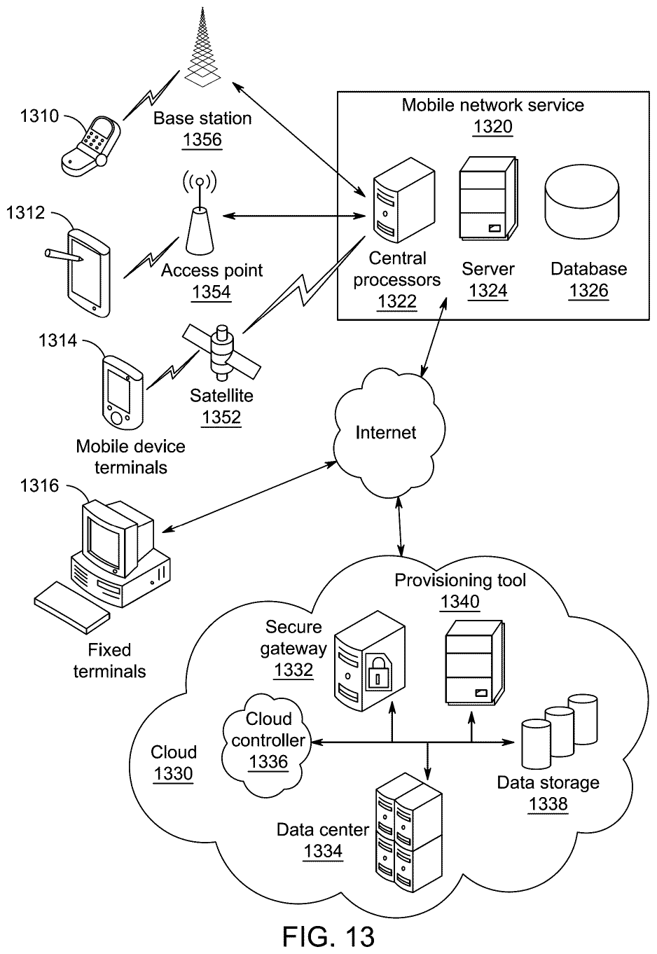

The functions and features described herein may also be executed by various distributed components of a system. For example, one or more processors may execute these system functions, wherein the processors are distributed across multiple components communicating in a network. The distributed components may include one or more client and server machines such as cloud 1330 including a cloud controller 1336, a secure gateway 1332, a data center 1334, data storage 1338 and a provisioning tool 1340, and mobile network services 1320 including central processors 1322, a server 1324 and a database 1326, which may share processing, as shown by FIG. 13, in addition to various human interface and communication devices (e.g., display monitors 1316, smart phones 1310, tablets 1312, personal digital assistants (PDAs) 1314. The network may be a private network, such as a LAN, satellite 1352 or WAN 1354, or base station 1356, or be a public network, may such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A method of planning a flight path of a plurality of unmanned aerial vehicles (UAVs) over one or more regions, comprising:
receiving a boundary information of the one or more regions;
decomposing the one or more regions into a plurality of point of interests (POIs) based on the boundary information;
determining a line sweep direction for each POI of the plurality of POIs to minimize a number of turns to achieve a predetermined coverage;
generating an intra-region path in each POI of the plurality of POIs;
generating a back-and-forth path pattern for the intra-region paths based on the line sweep direction;
formulating a problem matrix by calculating an inter-region energy;
solving the problem matrix with a heuristic approach and an exact approach; and
determining the flight path based on the heuristic approach and the exact approach.

2. The method of claim 1, wherein the problem matrix is formulated based on a mixed integer linear programming (MILP).

3. The method of claim 1, wherein the generating the intra-region path further comprises:
finding a swap direction of each POI of the plurality of POIs;
creating a rough intra-region path based on a back-and-forth model;
adjusting the rough intra-region path based on a smoothing turns approach;
calculating an intra-region energy; and
generating the intra-region path in each POI of the plurality of POIs.

4. The method of claim 3, wherein the smoothing turns approach minimizes an energy consumption during a turning maneuver of a UAV of the plurality of UAVs.

5. The method of claim 4, wherein the smoothing turns approach reduces the energy consumption based on a deceleration, a rotation, and an acceleration of the turning maneuver of the UAV of the plurality of UAVs.

6. The method of claim 3, wherein the smoothing turns approach uses Bezier curves configured to reduce a turn sharpness.

7. The method of claim 3, wherein the flight path is determined based on a number of UAVs of the plurality of UAVs, the intra-region energy, and the inter-region energy.

8. The method of claim 7, wherein the flight path is determined further based on a Tabu Search algorithm and a greedy approach solution.

9. The method of claim 1, wherein the back-and-forth path pattern determines the line sweep direction perpendicular to a region's edge to minimize the number of turns.

10. The method of claim 1, wherein a UAV of the plurality of UAVs is configured to return to a base station for refueling based on a calculated remaining energy reserve.

11. The method of claim 10, wherein the determined flight path maximizes continuous UAV communication with the base station.

12. The method of claim 1, further comprising determining an updated flight path in real-time when a change in an environmental condition is detected.

13. The method of claim 1, wherein the determined flight path minimizes an overlap in covered areas between adjacent flight paths for each UAV of the plurality of UAVs.

14. The method of claim 1, wherein each UAV of the plurality of UAVs is equipped with a downward-facing imaging device, and the predetermined coverage is determined based on image data from the imaging device.

15. The method of claim 1, further comprising determining an energy consumption for the intra-region path based on a number of waypoints and a number of turns in the intra-region path.

16. The method of claim 1, further comprising calculating an energy consumption for an inter-region path based on a distance between an exit point of a first region and an entry point of a second region.

17. The method of claim 1, further comprising grouping the one or more regions into clusters based on a number of the plurality of UAVs available and a spatial distribution of the one or more regions.

18. The method of claim 1, further comprising determining a region allocation by assigning the one or more regions to the plurality of UAVs based on starting positions of the plurality of UAVs and energy capacities of the plurality of UAVs.

19. The method of claim 1, further comprising calculating energy requirements for the intra-region path based on takeoff, hovering, cruise, turning, and landing.

20. The method of claim 1, wherein the plurality of UAVs maintain a fixed altitude during operation.
